(19) United States
(12) Patent Application Publication
(10) Pub. No.: US 2026/0359889 A1
(43) Pub. Date: Nov. 12, 2026

(54) SYSTEMS AND METHODS FOR DYNAMIC TRUSTWORTHINESS ASSESSMENT

(71) Applicant: The PNC Financial Services Group, Inc., Pittsburgh, PA (US)

(72) Inventors: Robert J. Schukai, Marietta, GA (US); Deanna N. Gilbert, Arlington Heights, IL (US); Minette Vaccariello, Pittsburgh, PA (US); Brianna K. Hogan, Coraopolis, PA (US); Melissa Morello, Pittsburgh, PA (US); Touseef Habib, Secaucus, NJ (US)

(73) Assignee: The PNC Financial Services Group, Inc., Pittsburgh, PA (US)

(21) Appl. No.: 19/664,607

(22) Filed: Apr. 30, 2026

Related U.S. Application Data
(60) Provisional application No. 63/802,133, filed on May 8, 2025.

(51) Int. Cl. G06Q 40/03

(52) U.S. Cl. CPC G06Q 40/033

(57) ABSTRACT

A system is disclosed for generating personalized content. The system may include at least one processor configured to execute the instructions to perform operations. The operations may include receiving user data into a database; partitioning the user data in the database, the partition configured to separate out the user data indicating the user activity or the user inactivity; filtering the partitioned user data based on a category of user activity; classifying, using a machine learning model, the partitioned user data as high value, intermediate value, or low value, the machine learning model trained to recognize an impact of the user activity or user inactivity on a perceived trustworthiness of a user; assigning weight to the partitioned user data based on the category of user activity and the classification; and calculating, using a statistical trust model, a risk assessment score, the statistical trust model configured to predict trustworthiness of the user.

### CROSS REFERENCE TO RELATED APPLICATIONS

This application claims priority from U.S. Provisional Application No. 63/802,133, filed on May 8, 2025, the entirety of which is incorporated by reference.

### BACKGROUND

A variety of lending tools exist to determine the creditworthiness of prospective users. Determining creditworthiness warns institutions of the risks associated with lending to a particular user and informs an institution's decision of whether to lend and under which terms.

Lending risk analysis tools often involve a credit score such as a Fir Isaac Corporation (FICO) score. A FICO score is a credit score, a three-digit number that reflets a user's creditworthiness and risk of defaulting on debt. Credit scores influence users' ability to access credit, impacting loan approval, interest rates, or even insurance premiums. Users' credit records reflect their creditworthiness, making it easier or harder to receive loans, credit cards, and other financial products at favorable terms. For example, a good credit score may make it easier for a user to qualify for loans like mortgages, auto loans, and personal loans; receive favorable loan terms such as a longer duration and lower monthly payments; access credit cards with higher limits or more rewards; and have rental applications approved.

Credit is the ability of a user to obtain goods and services before payment, based on the trust that payment will be made in the future. Conventional credit scores consider a user's reputation and credit history, including repayment history, a user's financial resources such as their assets and savings, what collateral a user has available to pledge, current economic conditions, and industry trends. Despite the existence of several lending tools for determining creditworthiness, conventional lending risk analysis tools view the term trust narrowly and assess only a limited set of categories. As a result, some users, who have demonstrated trustworthiness in other areas of their life but are deemed higher than desired credit risk according to their credit scores, are unable to obtain financial products and services on favorable terms, if at all. Moreover, recent immigrants who demonstrate trustworthiness in other areas of their lives or who have a history of demonstrated financial trustworthiness cannot demonstrate their financial trustworthiness in the United States through the use of a credit score simply because they lack United States credit history. Institutions do not currently have an effective way to determine user trustworthiness or to apply a broader definition of trustworthiness than that currently applied to credit to perform lending risk analysis (i.e., a credit score). What is needed is a system for determining a user trustworthiness score for lending risk analysis.

Moreover, credit scores may be inadequate for determining a user's creditworthiness with respect to a specific financial instrument. For example, a user may may treat loan repayment differently as between credit cards and mortgages. Moreover, a user may disfavor spending via a credit card and instead spend using a debit card. Such spending may not impact the user's credit score, but it may demonstrate financial responsibility. Furthermore, recent changes to a user's financial or non-financial situation may impact trustworthiness without being reflected in the user's credit score. For example, a job loss followed by a large loan request may be indicative of an inability to repay the loan but may not yet be reflected in the user's credit score. As such, what is needed is a dynamic trustworthiness assessment that can be tailored to financial instruments and reflect updates to a user's trustworthiness.

### SUMMARY

In view of the foregoing, embodiments of the present disclosure address disadvantages of existing conventional systems and methods by providing novel computer-implemented systems and methods for dynamic trustworthiness assessment.

Embodiments of the present disclosure provide a computer implemented system, such as a smart risk analysis lending platform, for determining a user trustworthiness score. The smart risk analysis lending platform may include a memory storing a set of instructions. The smart risk analysis lending platform may include a database in electronic communication with the memory. The smart risk analysis lending platform may include a processor in electronic communication with the database. The database may be configured to store information that includes information about businesses in a network associated with an institution, user information, and account and activity information. The information may be associated with a business or a business account. The user information may be associated with a user or account. The account and activity information may be associated with the user or the business.

The processor may be configured to execute a set of instructions. The set of instructions may include receiving user data into a database, the user data matching criteria directed to identifying the user data as indicating either user activity or user inactivity; partitioning the user data in the database, the partition configured to separate out the user data indicating the user activity or the user inactivity, based on the criteria; filtering the partitioned user data based on a category of user activity; classifying, using a machine learning model, the partitioned user data as high value, intermediate value, or low value, the machine learning model trained, using historical user data and historical classifications, to recognize an impact of the user activity or the user inactivity on a perceived trustworthiness of a user, the training involving: assessing a likelihood that the user activity or the user inactivity indicates that a user is more or less trustworthy based on the historical user data and the historical classifications, assigning a value of high value, intermediate value, or low value, based on the likelihood, evaluating the assignment based on an evaluation criteria, and revising the assignment into a classification as high value, intermediate value, or low value based on the evaluation; assigning a weight to the partitioned user data based on the category of user activity and the classification, the weight indicating a significance of the user activity or the user inactivity; and calculating, using a statistical trust model, a risk assessment score, the statistical trust model configured to predict trustworthiness of the user by summing a base risk assessment score and an impact associated with the user activity or the user inactivity, where the impact is a product of a nonlinear, time-weighted penalty curve function and the weight.

In some embodiments, the instructions may further include the step of pushing a notification to a user device, the notification offering the user a financial knowledge course and assessment. In some embodiments, completing the financial literacy course may increase the risk assessment score of the user. In some embodiments, users may be incentivized to share third-party data.

In some embodiments of the present disclosure, the set of instructions may include receiving user data into a database; partitioning the user data in the database; filtering the partitioned user data based on the category of user activity; receiving credit activity into a database; requesting a credit score history, the credit score history being a chronological record of a credit score associated with the user; classifying the credit activity as being positive credit activity or negative credit activity based on an estimated contribution of the credit activity to the credit score, the estimate contribution based on the credit score history; classifying, using a machine learning model, the partitioned user data as trustworthy or untrustworthy; and/or comparing the classified credit activity and the classified partitioned user data to match the classified partitioned user data with the classified credit activity based on the estimated contribution and the classifications.

In some embodiments, the instructions may further include the step of determining that the risk assessment score surpasses a threshold. In some embodiments, the instructions may include delivering a message to a user device upon detecting the risk management score surpasses the threshold. In some embodiments, the message may advise the user regarding how to improve the risk management score. In some embodiments, the user may be prompted to sign up for a smart risk analysis lending platform.

Another aspect of the present disclosure is directed to a method. The method may perform operations including identifying a business in a network associated with an institution; detecting, from the user activity, a user interaction with the business by continuously monitoring the user data and flagging an instance of the business; prompting the business to provide user interaction data by delivering an authorization request to an administrator; and receiving the user interaction data into the database upon the administrator granting the authorization request.

Yet another aspect of the present disclosure is directed to a method. The method may perform operations including receiving an application for a financial instrument into an application workflow service, the application workflow service configured to process the application and issue either a grant or a rejection of the application. In some embodiments, the operations may include receiving financial instrument data into a database for a predetermined period of time.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by a processor that is configured as a special-purpose processor based on software instructions that are programmed with logic and instructions that perform, when executed, one or more operations consistent with the disclosed embodiments.

Throughout this disclosure the phrase “disclosed embodiments” refers to examples of ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic. It is to be understood that both the foregoing general description and the following detailed description are exemplary and explanatory only, and are not restrictive of the disclosed embodiments, as claimed.

### BRIEF DESCRIPTION OF THE DRAWINGS

Embodiments and various aspects of the present disclosure are illustrated in the following detailed description and the accompanying figures. Various features shown in the figures are not drawn to scale. Identical reference numerals generally represent identical components in the exemplary implementations of the present disclosure.

FIG. 1 depicts an exemplary illustration of a user using a computing device to perform lending risk analysis of a user, consistent with disclosed embodiments.

FIG. 2 depicts an exemplary illustration of a user using a computing device to receive a risk assessment score, consistent with disclosed embodiments.

FIG. 3 depicts a block diagram showing an exemplary computing device, consistent with disclosed embodiments.

FIG. 4 depicts a flow chart for a method of calculating a risk assessment score, consistent with disclosed embodiments.

FIG. 5 depicts a flow chart for a method of providing application feedback to a user, consistent with disclosed embodiments.

FIG. 6 depicts a flow chart for a method of mapping creditworthiness to trustworthiness, consistent with disclosed embodiments.

FIG. 7 depicts a flow chart for a method of providing trustworthiness feedback to a user, consistent with disclosed embodiments.

FIG. 8 depicts a flow chart for a method of providing feedback to a user, consistent with disclosed embodiments.

FIG. 9 depicts a flow chart for a method of incentivizing granting access to user data, consistent with disclosed embodiments.

FIG. 10 depicts a flow chart for a method of assessing financial literacy of a user, consistent with disclosed embodiments.

FIG. 11 depicts a flow chart for a method of assessing user behavior, consistent with disclosed embodiments.

FIG. 12 depicts a flow chart for a method of determining a risk assessment score, consistent with disclosed embodiments.

FIG. 13 depicts a flow chart for a method of assessing trustworthiness of a user, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limiting.

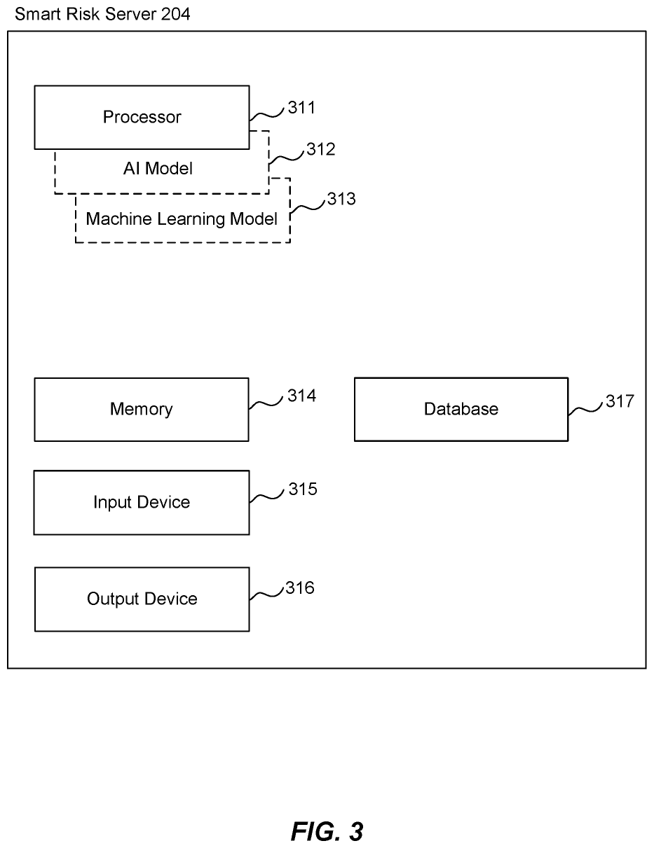

Embodiments herein include computer-implemented methods, tangible non-transitory computer-readable media, and systems. The computer-implemented methods may be executed, for example, by at least one processor (e.g., a processing device), as described with respect to FIG. 3, that receives instructions from a non-transitory computer-readable storage medium. Similarly, systems consistent with the present disclosure may include at least one processor (e.g., a processing device) and a memory, and the memory may include a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, non-volatile memory, hard drives, compact disc (CD) ROMs, digital optical discs (DVDs), flash drives, disks, and/or any other known physical storage medium. Singular terms, such as “memory” and “computer-readable storage medium,” may additionally refer to multiple structures, such as a plurality of memories and/or computer-readable storage mediums. As referred to herein, a “memory” may include any type of computer-readable storage medium unless otherwise specified. A computer-readable storage medium may store instructions for execution by at least one processor, including instructions for causing the processor to perform steps or stages consistent with an embodiment herein. Additionally, one or more computer readable storage mediums may be utilized in implementing a computer-implemented method. The term “computer-readable storage medium” should be understood to include tangible items and exclude carrier waves and transient signals.

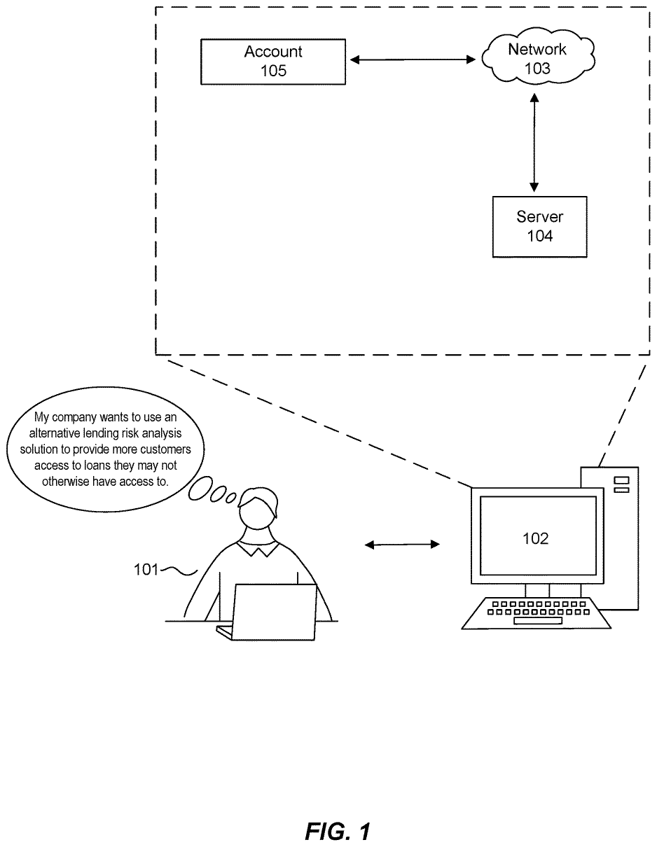

FIG. 1 depicts an exemplary illustration of user 101 using computer 102 to perform lending risk analysis. User 101 considers: “My company wants to use an alternative lending risk analysis solution to provide more customers access to loans they may not otherwise have access to.” User 101 then uses computer 102 to assist with determining lending risk. User 101 may use computer 102 to assess a variety of financial metrics of a customer who may be a prospective borrower. User 101 may investigate the customer's payment records, such as records of on-time or late payments on credit cards, loans, or mortgages and into the customer's total debt and credit utilization ratio. User 101 may look into the length of the customer's credit history, an age of the customer's oldest credit account, the age of the customer's youngest credit account, and an average age of all credit accounts. User 101 may also assess the diversity of the customer's credit portfolio, such as whether the customer has credit cards, auto loans, or a mortgage. User 101 may also look into how many recently opened and inquired about credit accounts the customer has. User 101 may then look into the customer's net worth, income, collateral, and other factors and use the information to determine a risk of lending to a customer.

The exemplary illustration may include network 103, server 104, and account 105. User 101 may request or access the customer's financial information and metrics from server 104. Computer 102 may communicate and send data over network 103 and may store the determined risk of lending on server 104 or in account 105.

Account 105, as described herein, may refer to a record of information, such as financial information and transactions. Account 105 may also contain personal information about a customer such as name and birthday or account information such as holdings, balances, when the account was opened, withdrawals, deposits, regular and irregular account activity, debts, automatic transaction settings, loans, payment history, and interest earned.

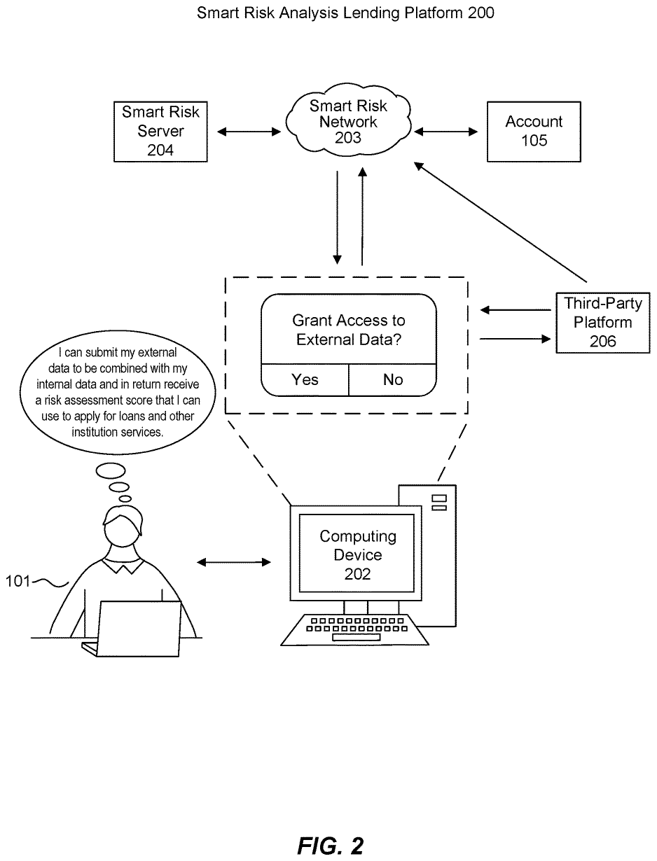

FIG. 2 depicts an exemplary illustration of a user using computing device 202 to use smart risk analysis lending program 200 receive a risk assessment score. In some embodiments, the risk assessment score may be a trustworthiness score, which may be a numerical score calculated by assessing user activity and user inactivity according to trustworthiness. Smart risk analysis lending platform, as described herein, may refer to a combination of hardware and software used for execution and deployment of lending risk analysis. Lending risks may refer to dangers associated with lending such as potential of borrowers to default and not repay their debts, financial losses, interest rate increases, and market risks. Risk analysis may involve analyzing data to help institutions and other lenders decide whether to lend money to a user and under what conditions.

Computing device 202, as described herein, may refer to a device that may connect to a network and run applications. In some embodiments, a computing device may be a desktop computer, laptop computer, or mobile device. User 101 may consider: “I can submit my external user data to be combined with my internal data and in return receive a risk assessment score that I can use to apply for loans and other institution services.” In some embodiments, user 101, as described herein, may refer to a customer, borrower, lender, financial institution, or financial professional. User may then use computing device 202 to respond to a notification, asking user 101 to grant or deny access to the user's external user data, such as third-party data. If user 101 grants access to the third-party data, computing device 202 may transmit a message to third-party platform 206 requesting the release of the third-party data. Third-party platform 206 may then transmit data to smart risk server 204 over smart risk network 203.

Smart risk network 203, as described herein, may refer to an environment in which relevant activities of user 101 on computing device 202 may be recorded and stored for future access. In some embodiments, a result of the smart risk lending analysis may be stored in smart risk server 204 or account 105, as described with respect to FIG. 1, such that the result may be associated with user 101. The recording, transmission, and storage of the recorded user activity may be performed in a secure manner, such that only an institution and user 101 may have access to the recorded activity.

Such communications over smart risk network 203 may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, communications may take place across two or more of these forms of networks and protocols. In other embodiments, smart risk network 203 may also be a localized system, with one or more of the components communicating directly with each other.

Smart risk server 204, as described herein may refer to one or more digital and/or analog devices that allow communication with other machines and devices. Computing device 202, smart risk server 204, account 105, and third-party platform 206 may communicate with one another over smart risk network 203. Third-party platform 206, as described herein, may refer to websites, applications, or databases containing external user information. User 101 may interact with a service provider or products outside of an institution. The service provider may collect a variety of data on user 101 different than that collected by the institution. Such information may be indicative of a user's trustworthiness and be useful for conducting lending risk analysis. Smart risk analysis lending platform 200 may push a request to a user's computing device 202 requesting access to certain data from third-party platform 206.

In some embodiments, third-party platform 206 may be a rental portal that contains data on a user's rental payment history. In some embodiments, third-party platform 206 may be a utility company account that contains data on a user's utility payment history. In some embodiments, third-party platform 206 may be a department of motor vehicles account or tollway account that contains data on how many parking and speeding tickets user 101 has received and paid and a user's toll payment history. In some embodiments, third-party platform 206 may be a peer-to-peer payment application that contains data on a user's payment requests and transmittals. In some embodiments, third-party platform 206 may be an academic institution account that contains data on a user's grades, achievements, scholarships, and degrees earned. In some embodiments, third-party platform 206 may be a community account that contains data on a user's volunteering efforts. In some embodiments, third-party platform 206 may be a financial wellness application that contains data on a user's financial literacy. In some embodiments, third-party platform 206 may be a stock or retirement account that contains data on a user's retirement and investment contributions. In some embodiments, third-party platform 206 may be a gambling profile that contains data on a user's gambling history.

Within smart risk server 204, the third-party data may be received into a database, as described with respect to FIG. 3. In some embodiments, user 101 may have immediate access to the third-party data and may use computing device 202 to transmit the external user data to smart risk server 204 over smart risk network 203 where it may be received into the database.

User data may also be transmitted from account 105 to smart risk server 204, over smart risk network 203, where it may be received into the database. A processor, as further described with respect to FIG. 3, may use a machine learning model, as further described with respect to FIG. 3, to assess user data. The processor may also be used to calculate a risk assessment score. The risk assessment score may be stored in the database or in account 105, and user 101 may be notified when their risk assessment score is calculated and ready to use. Risk assessment score, as described herein, may refer to a numerical score representative of the user's traits, such as trustworthiness, that may be used as an alternative to traditional lending risk measures to secure an institution's services, such as loans.

Machine learning model, as described herein, may refer to a set of instructions that enable computing devices to learn from data, make predictions and improve their performance overtime with no or minimal human programming. Machine learning model may refer to a model that can find patterns or make decisions from a dataset. Various machine learning models may be implemented by taking in data and classifying the data as low value, intermediate value, or high value. In doing so, the machine learning model may recognize an impact of the user activity or the user inactivity on a perceived trustworthiness of user 101. The data may include, for example, user data, third-party data, user interaction data, financial instrument data, and external user data. In some embodiments, the data may be partitioned. For example, the machine learning model may receive and classify partitioned user data, partitioned third-party data, partitioned user interaction data, partitioned financial instrument data, or partitioned external user data.

User data, as described herein, may refer to data relating to user 101 that is held by the institution and thus may be internal. User data may include information personally identifying information, such as name, date of birth, age, and address; transaction information, such as deposits, purchases, withdrawals, merchant information, date and time, location, and transaction type, such as automated teller machine withdrawal or credit/debit card purchase; account information, such as account number, account age, account balance, loan amounts, credit limits, and overdraft history; credit and risk information, such as credit score, repayment history, debt-to-income ratio, and collateral information; and behavioral and usage information, such as online banking login frequency, mobile application usage, and response to marketing content. In some embodiments, user data may include information about user 101 that user 101 voluntarily provides to the institution, such as that user 101 is a student, gets good grades, makes donations, does volunteer work, or helps out family or a neighborhood. In some embodiments, such user information may be provided to the institution by submission of letters of recommendation, testimonial statements, online forms, or other materials.

Third-party data, as described herein, may refer to information that a third party, such as a merchant, investment institution, financial institution, educational institution, service provider, employer, or non-profit organization hold related to user 101. The third-party data may include information about user 101 and the user's transactions or dealings with the third party. The third-party data may also include interaction data, such as user interaction data. Interaction data may include the method and frequency of user 101 interacting with the third party or with a business in a network associated with an institution. For example, if the third party is a gambling service, the interaction data may include a size and frequency of bets, a subject of the bet, and whether the bet was placed online, over the phone, on a mobile application, or in a casino. In another example, if the third party is an investing institution, the interaction data may include the method and frequency at which user 101 logs into their account, purchase or sale of investments, or information about a user's automated investment transactions.

Financial instrument data, as described herein, may refer to user data specifically related to a financial instrument. Financial instrument, as described herein, may refer to a monetary contract between parties or a monetary device that acts as a financial asset to one party and a financial liability to another party. In some embodiments, the financial instruments may be a credit card, a debit card, a stock, a bond, a mutual fund, a loan, or a mortgage. For example, for a credit card, financial instrument data may include a user's name, an account number, an account balance, transaction information, an account age, and a payment history.

The data may cover user activity and user inactivity, including financial activity, financial-adjacent activity, and non-financial activity. Financial activity, as described herein, may refer to activity or inactivity directly related to a user's finances or financial institution. Such activity may include transactions with a third party, deposits, withdrawals, transfers of funds, timely or late payments, negative payments such as paying for parking tickets or unused subscriptions, and short and long term loans. Financial-adjacent activity, as described herein, may refer to user activity or user inactivity related to the user's finances but not directly connected to the user's financial institution or activity and that may impact finances. Such activity may include gambling; rent and utility payments; payroll information, such as whether user 101 uses direct deposit or checks and whether and how much user 101 contributes to retirement and health savings accounts; taking courses or reading material on financial literacy; making or taking out inter-or intra-family loans; that user 101 handles other people's money during the course of their employment; and making donations. Non-financial activity, as described herein, may refer to user activity or user inactivity unrelated to a user's finances but that may be reflective a user's character or trustworthiness or how user 101 may treat their finances. Such activity may include that user 101 makes decisions to stay in good health; user 101 is a safe driver; user 101 takes care of a younger sibling, a relative, or a neighbor; user 101 does volunteer work, user 101 is a student and gets good grades, user 101 is pursuing an advanced degree, user 101 attends the events they register for, and user 101 has a pet.

In some embodiments, the machine learning model may classify data as indicating user 101 is trustworthy or untrustworthy. The machine learning model may associate credit activity indicative of creditworthiness with user data indicative of trustworthiness. In some embodiments, the machine learning model may classify credit activity as being positive credit activity or negative credit activity. The machine learning model may estimate a contribution of the credit activity to a credit score.

The machine learning model may utilize several steps for operation. The machine learning model may use a query system to draw in and ingest new data and may use preprocessing and transformation steps to clean, normalize, and transform data before storing it. In some embodiments, data may be stored indefinitely while in other embodiments data be stored for a shorter period of time such as for as long as the data is relevant. For example, user data may be stored until user 101, who may be a customer at an institution, associated with the user data ceases to be a customer. The machine learning model may also use a monitoring operation to monitor data flow, detect anomalies, or ensure data optimization. In some embodiments, the machine learning model may have a trigger for retraining. In some embodiments, ingestion of new data may trigger retraining or fine tuning of the machine learning model. In some embodiments, the machine learning model may be retrained after a period of time, such as one month, one year, or some other period of time. In some embodiments, the machine learning model may be trained using historical data and may continuously adjust internal parameters. In some embodiments, the machine learning model may be validated using separate datasets to assess accuracy, precision, recall, and other metrics. The machine learning model may be able to output a variety of data including scores, classifications, and recommendations. The machine learning model may be configured to accept a variety of inputs, including text, image, audio, time series inputs, categorical inputs, numerical inputs.

For example, in some embodiments, the machine learning model may be used to classify user data, such as partitioned user data, as high value, intermediate value, or low value based on a likelihood that the user data may indicate user 101 associated with the user data is trustworthy or untrustworthy. User data related to user activity or user inactivity having an indication that user 101 is very trustworthy or very untrustworthy may be classified as high value, and user data related to user activity or user inactivity that is irrelevant to trustworthiness may be classified as low value. For example, user data that shows user activity related to buying groceries may be irrelevant to the user's trustworthiness and may be classified as low value, but user data showing the user activity related to user 101 buying groceries for an elderly neighbor every week may be classified as high value. In some embodiments, high value, intermediate value, and low value, may each be associated with a numerical multiplier for use in calculating the risk assessment score, where the numerical multiplier for high value may be greater in value than the numerical multiplier for intermediate value, which may be greater in value than the numerical multiplier for low value.

The machine learning model may be trained to recognize an impact of the user activity or the user inactivity on a perceived trustworthiness of user 101. The machine learning model may be trained in a variety of ways. For example, the machine learning model may be trained from historical trust data, including historical user data and historical classifications. The historical trust data may include user activity and user inactivity, as well as whether and how the activity, or a category of user activity, impacts an institution's decision on the trustworthiness of user 101. The historical trust data may be data from a period of time, such as one month or one year, prior to present day. In some embodiments, the activity, or category of user activity, may involve reliability and consistency, accountability and honesty, interpersonal integrity, ethical conduct, or transparency and cooperation. The historical trust data may include that the activity aligns with behavior of a trustworthy user, does not align with the behavior, has little to no relevance to trustworthiness, or has only some relevance to trustworthiness. In some embodiments, the machine learning model may be trained to recognize that activity, or a category of user activity, that does not involve reliability and consistency, accountability and honesty, interpersonal integrity, ethical conduct, or transparency and cooperation may have little to no relevance to trustworthiness and may thus be best classified as low value.

In one embodiment, the machine learning model may be trained from user activity and user inactivity. The machine learning model may receive the user activity or the user inactivity, such as a user's transactions and when the transactions were made, the user's involvement with third parties, or information about user 101 or the user's relationships. The machine learning model may be trained to recognize that user activity or user inactivity involving reliability and consistency, accountability and honesty, interpersonal integrity, ethical conduct, or transparency and cooperation are generally indicative of trustworthiness or untrustworthiness and may be best classified as high value. For example, the machine learning model may receive user activity and user inactivity showing that user 101 uses the institution's mobile application to access their account at least once per week, user 101 moved residences in January and updated their mailing address information in their account later that month, and, when the institution left a voicemail on a user's answering machine on a Friday requesting to conduct an annual review of the user's performance, user 101 returned the call the following Monday to schedule a meeting.

During training, the machine learning model may be trained that user activity involving engagement with the user's account indicated the user's interest or commitment to an account's content, and therefore user 101 is likely to be aware of an account's performance and may be trusted to act in response to the account's performance. For example, when user 101 uses the institution's mobile application to access their account at least once per week, the machine learning model may be trained that user 101 that frequently checks their account is likely consistent in their actions, is proactive, and is invested in their accounts performance. The machine learning model may learn that consistent and proactive actions are valuable for accessing trustworthiness and may be best classified as high value.

Similarly, the machine learning model may be trained to recognize that user activity involving engagement with the institution or promptly updating account information demonstrates reliability which is likely valuable for assessing trustworthiness and may be best classified as high value. For example, the machine learning model may be trained that user 101 moving residences in January and updating their mailing address in their account later that month shows user 101 is transparent about changes to their account and proactive about recording those changes. Similarly, the machine learning model may be trained that user 101 promptly returning a call from the institution to set up a meeting about their performance shows user 101 is cooperative. The machine learning model may be trained that user activity and user inactivity showing transparency and cooperation are likely relevant to trustworthiness and may be best classified as high value.

Just as the machine learning model may be trained on which user activity and user inactivity may be best classified as high value, the machine learning model may be trained to recognize which user activity and user inactivity may be best classified as intermediate value. The machine learning model may again be trained from user activity and user inactivity. The machine learning model may be trained to recognize that user activity or user inactivity may not be directly related to the trustworthiness of user 101 but may have some relation to a user's trustworthiness and therefore may be best classified as intermediate value. For example, the machine learning model may receive user activity and user inactivity showing that user 101 is a college student with a below-average grade point average, user 101 owns and takes care of a dog, and user 101 makes several negative payments each month. Negative payments, as described herein, may refer to an avoidable payment or transaction where user 101 pays a fee for committing a misdeed or user 101 pays for a product or service that user 101 does not use. For example, a negative payment may include a fee for a parking ticket, a fee for a speeding ticket, or a monthly fee for a subscription user 101 does not utilize.

During training, the machine learning model may be trained to recognize that user activity involving good performance, providing for someone or something, and making avoidable payments, while not directly tied to trustworthiness, may have some impact on whether user 101 is deemed trustworthy or untrustworthy and therefore may be best classified as intermediate value. For example, the machine learning model may be trained that user 101 having a below-average grade point average may indicate that user 101 is unable to adequately fulfill their responsibilities or that user 101 is not diligent. The machine learning model may be trained that a user's diligence or motivation may factor into the perceived trustworthiness of user 101, so the user activity may be best classified as intermediate value.

In another example, the machine learning model may be trained that user 101 owning and taking care of a dog shows responsibility and compassion which, while not directly related to trustworthiness, may impact the perceived trustworthiness of user 101 and therefore may be best classified as intermediate value. In another example, the machine learning model may be trained that user activity related to negative payments may indicate a lack of care or responsibility. The machine learning model may learn that, while not directly related to trustworthiness, acting with care and responsibility may impact the perceived trustworthiness of user 101, so the user activity may be best classified as intermediate value. The machine learning model may also be trained that the classification may be based on the user activity's impact on the perceived trustworthiness of user 101 rather than whether the user activity indicates trustworthiness or untrustworthiness. For example, the user making negative payments may indicate user 101 is untrustworthy and user 101 owning and caring for a dog may indicate user 101 is trustworthy. However, since both relate to responsibility which, while not directly related to trustworthiness, may impact the perceived trustworthiness of user 101, both may be categorized as having intermediate value.

Just as the machine learning model may be trained on which user activity and user inactivity may be best classified as high value and intermediate value, the machine learning model may also be trained to recognize when the user activity or the user inactivity is not relevant to an assessment of trustworthiness and therefore may be classified as low value. For example, the machine learning model may receive user data including that user 101 went grocery shopping three times during one month but two times during the previous month and user 101 traveled to State S once per year for the past four years. During training, the machine learning model may be trained that not all user activity or user activity is relevant to the trustworthiness of user 101. The machine learning model may be trained that user activity involving day-to-day or infrequent transactions, such as purchasing food at a grocery store, buying a shirt from a retailer, or planning a trip, without supplemental user data, may not be relevant to the trustworthiness of user 101 and therefore may be best classified as low value.

The machine learning model may learn from the examples and go through further training of receiving user activity for a period and classifying the user activity as high value, intermediate value, or low value. For each set of user activities, the machine learning model may assess the likely impact of the user activity on the perceived trustworthiness of user 101 and determine a classification for the user activity. The classification may then then be confirmed or corrected until the machine learning model is able to make accurate determinations a threshold amount of the time.

For example, the machine learning model may receive user activity including that user 101 received notice that their password expired six months ago but has not reset it yet, user 101 updated their income information on their account shortly after starting a new job, user 101 contributes the maximum amount to a retirement account, and user 101 spends more money on groceries during the first week of each month than during the other weeks of the month since user 101 brings groceries to an elderly neighbor. The machine learning model may determine that user 101 receiving notice that their password is expired and not resetting the password for over six months may indicate that user 101 is not receptive to requests, is irresponsible, or is uncooperative. The machine learning model may recognize that receptiveness, responsibility, and cooperation correlate to trust and are likely to impact the perceived trustworthiness of user 101. The machine learning model may then classify the user inactivity of failing to reset the password as high value. The machine learning model may be informed that its determination was correct and continue training.

In another example, the machine learning model may determine that user 101 promptly updating their income information in their account is reflective of the user's proactivity and transparency. The machine learning model may recognize that user activity showing proactivity and transparency is likely to impact the perceived trustworthiness of user 101 and should therefore be classified as high value. The machine learning model may again be informed that its determination was correct and continue training.

In another example, the machine learning model may determine that user 101 promptly updating their income information in their account is reflective of the user's proactivity and transparency. The machine learning model may recognize that user activity showing proactivity and transparency is likely to impact the perceived trustworthiness of user 101 and should therefore be classified as high value. The machine learning model may again be informed that its determination was correct and continue training.

In another example, the machine learning model may determine that user 101 actively contributing to a retirement account is user activity that is not directly tied to trustworthiness but shows that user 101 may be responsible, financially literate, and invested in their future. The machine learning model may determine that user activity showing responsibility and initiative, though not directly related to trustworthiness, may impact the perceived trustworthiness of user 101 and so user 101 contributing the maximum amount to the retirement account should be classified as intermediate value. The machine learning model may be informed that its classification was correct and continue training.

In another example, the machine learning model may determine that user 101 spending more money on groceries during the first week of each month than during the other weeks of the month since user 101 brings groceries to an elderly neighbor may be a routine transaction and not likely relevant to trustworthiness. The machine learning model may determine that user activity involving routine, or day-to-day, transactions are not likely to impact the perceived trustworthiness of user 101 and should be classified as low value. The machine learning model may be informed that its classification was incorrect and provided the correct classification of intermediate value. The machine learning model may be trained that while such user activity is ordinarily low value, the information that user 101 brings groceries for their elderly neighbor may indicate that user 101 is reliable and dependable. The machine learning model may learn that user activity involving reliability or dependability, while not necessarily directly related to trustworthiness, may impact the perceived trustworthiness of user 101 and should be classified as intermediate value. After the machine learning model's classification is corrected, the machine learning model then continue training from additional examples.

The machine learning model may be configured to accept specific inputs. For example, the machine learning model may receive data such as user data, including user activity and user inactivity. In some embodiments, the machine learning model may receive and classify other data, such as third-party data or interaction data. In some embodiments, the data may be partitioned into data involving user activity and data involving user inactivity. The machine learning model may receive the data, recognize an impact of the user activity or the user inactivity on a perceived trustworthiness of user 101, and classify the user activity as one of either high value, intermediate value, or low value. The machine learning model may then output the classification which may be used to determine the risk assessment score.

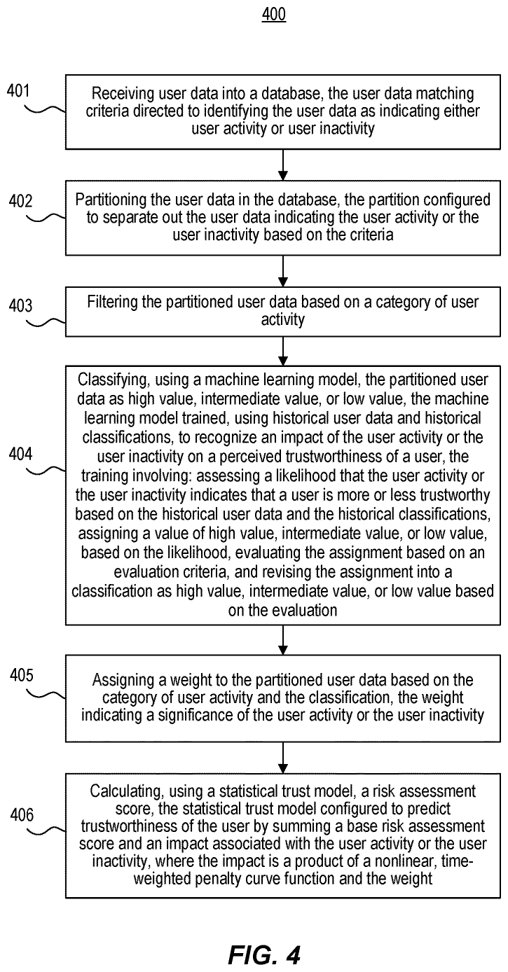

In some embodiments, the risk assessment score may be calculated using a statistical trust model, as further described in FIG. 4. The statistical trust model may be configured to predict trustworthiness of user 101 by summing a base risk assessment score and an impact associated with the user activity or the user inactivity, where the impact is a product of a nonlinear, time-weighted penalty curve function and the weight. In some embodiments, the inputs may include the category of user activity; the classification of the partitioned user data, such as partitioned user data, partitioned third-party data, partitioned user interaction data, partitioned financial instrument data, or partitioned external user data; a weight assigned to the partitioned user data, further described with respect to FIG. 4, and historical trust data.

The statistical trust model, as described herein, may refer to a model that quantifies the trustworthiness of user 101 by using historical trust data, probabilities, weights, and decaying penalties. Nonlinear, time-weighted penalty curve function, as described here may refer to a mathematical function used to adjust an impact of past user activity and user inactivity based on how long ago the user activity or the user inactivity occurred. The nonlinear, time-weighted penalty curve function may cause a penalty, or a decrease in a user's overall trustworthiness and risk assessment score due to user activity deemed untrustworthy, to be more intense in the short term but lessen as time passes. Similarly, the nonlinear, time-weighted penalty curve function may cause a boost, or an increase in the user's overall trustworthiness and risk assessment score due to user activity deemed trustworthy, to be intense in the short term and increasingly less intense as time passes. In some embodiments, user activity deemed trustworthy may be treated differently than user activity deemed untrustworthy. For example, in some embodiments, user activity deemed trustworthy may not lose its impact over time or may lose its impact much more gradually than user activity deemed untrustworthy. Further, in some embodiments, the boost from user activity deemed trustworthy may result in a smaller numerical change in the risk assessment score than a penalty from user activity deemed untrustworthy.

In some embodiments, different user activity and user inactivity may be weighted and classified, as further described in FIG. 4, such that different user activity and user inactivity may have differing impacts on the perceived trustworthiness of user 101. As a result, some user activity and user inactivity may have lasting effects while other user activity may have only short term effects. Another result of differing weights and classifications may be that different user activity and user inactivity may have greater or lesser impact on the risk assessment score.

In one embodiment, a curve function, representing an impact on a risk assessment score, may be Impact (t)=w(t)*P(x), where t may be time since the user activity, w(t) may be a nonlinear, time-weighted function, and P(x) may be a base impact for the magnitude of a user activity, x. In one embodiment, where the nonlinear, time-weighted penalty curve function is an exponential decay curve function, w(t)=e^{-λt} where λ>0 and is a speed of decay. The smaller λ is, the longer the impact of the user activity will last, and the larger λ is, the shorter the impact of the user activity will last. λ may have units of time matching the units of time, t. For example, if t is measured in day, then the unit for λ may be days. And, if t is measured in years, then the unit for λ may be years. In some embodiment, λ may be chosen based on a half-life. The half-life

$${T}_{\frac{1}{2}}$$

may be the time it takes for the impact to decrease by 50%. When speed of decay is based on half-life,

$$λ = \frac{ln ( 2 )}{{T}_{\frac{1}{2}}} .$$

In some embodiments, λ may be chosen so that the risk assessment score gradually recovers after an occurrence of user activity indicative of untrustworthiness. In some embodiments, λ may be different for different user activity or categories of user activity. For example, λ used for a user activity or category of user activity that is very indicative of untrustworthiness may have a value much greater than λ used for a user activity or category of user activity that is only slightly indicative of untrustworthiness.

In some embodiments, data, such as user data, third-party data, user interaction data, financial instrument data, and external user data, may be made up of user activity, user inactivity, and user interaction. Each user activity, user inactivity, and user interaction may have a predetermined base impact, P(x). For example, all user activity involving late payments may have a base impact, P(x)=−10. Then, each user activity, user inactivity, and user interaction may have a weight and/or classification, as further described with respect to FIG. 4, based on a severity of the user activity, user inactivity, or user interaction. Severity, as described herein, may refer to how much the user activity, user inactivity, and user interaction indicate trustworthiness or untrustworthiness.

For example, categories of user activity of financial activity, financial adjacent activity, and non-financial activity, may be assigned weights. For example, in one embodiment, it may be decided that user activity that is financial activity implicates trustworthiness the most and user activity that is non-financial activity may implicate trustworthiness the least. So, financial activity may be assigned a weight of 3, financial-adjacent activity may be assigned a weight of 2, and non-financial activity may be assigned a weight of 1.

Further, in one embodiment, user activity classified as high value may be associated with a numerical multiplier of 1.5, user activity classified as intermediate value may be associated with a numerical multiplier of 1, and user activity classified as low value may be associated with a numerical multiplier of 0.5,

The base impact may then be multiplied by the numerical multipliers of the weight and classification. Here, user activity involving making a late payment is financial activity, so the weight is 3, and activity involving making a late payment may be classified as high value which is associated with a numerical multiplier of 1.5. So, an adjusted impact may be calculated as −10*3*1.5=−45. The adjusted value may then be multiplied by the nonlinear, time-weighted function, w(t)=e^{-λt}. If the payment was only made one day late, then λ may be larger, such as 0.3. Here, the formula becomes Impact(t)=−45*e^{-0.3t}. If the user activity of making a payment one day late happened one day ago, then Impact(1)=45*e^{-0.3}≈−33.34. Thus, since the user activity of making a payment one day late may indicate of untrustworthiness, the risk assessment score may receive a penalty of a decrease of 45 points upon the occurrence of the user activity, but after one day, the risk assessment score may recover, as the penalty may only be a decrease of approximately 33.34 points. As user 101 engages in user activity, user inactivity, and user interaction, and as penalties and boosts lessen in impact over time, the risk management score may be in constant flux. When user 101 opens an account, the user may be a provided a base risk assessment score which may be an initial risk assessment score provided to every new user as a starting point. In some embodiments, the base risk assessment score may be predetermined.

FIG. 3 depicts a block diagram showing an exemplary computational device, consistent with disclosed embodiments. Smart risk server 204 may include one or more dedicated processors and/or memories. For example, smart risk server 204 may include processor (or multiple processors) 311, and memory (or multiple memories) 314.

Processor 311 may take the form of, but is not limited to, a microprocessor, embedded processor, or the like, or may be integrated in a system on a chip (SoC). Furthermore, according to some embodiments, processor 311 may be from the family of processors manufactured by Intel®, AMD®, Qualcomm®, Apple®, NVIDIA®, or the like. Processor 311 may also be based on the ARM architecture, a mobile processor, or a graphics processing unit, etc. The disclosed embodiments are not limited to any one type of processor. Processor 311 may include an artificial intelligence model 312 and/or a machine learning model 313. Artificial intelligence model 312, as described herein, may refer to one or more computer programs trained on data to recognize patterns and make decisions with no or minimal human programming.

Machine learning model 313, as described with respect to FIG. 2, may refer to one or more sets of instructions that enable computing devices, as described with respect to FIG. 2, to learn from data, make predictions and improve their performance overtime with no or minimal human programming. Machine learning model 313 may refer to a model that can find patterns or make decisions from a dataset. Various machine learning models 313 may be implemented by analyzing user data held by an institution and non-financial or financial-adjacent external user data to identify activity and behaviors that may indicate trustworthiness, give weight to various activities and behaviors, and assist in calculation of a user's risk assessment score or trustworthiness score. The trustworthiness score may be a numerical score and may be accompanied by a descriptive classifier, such as, for example, poor, okay, average, good, or excellent. In some embodiments, machine learning model 313 may be trained to map user behavior to trustworthiness or credit risk. Machine learning model 313 may utilize several steps for operation.

In some embodiments, machine learning model 313 may use a query system to draw in and ingest new data and preprocessing and transformation steps to clean, normalize, and transform data before storing it. In some embodiments, data may be stored indefinitely, while in other embodiments, data be stored for a shorter period of time such as for as long as the data is relevant. For example, third-party user data may be stored until the user associated with the external user data ceases to be associated with the institution. Machine learning model 313 may also use a monitoring operation to monitor data flow, detect anomalies, or ensure data optimization.

In some embodiments, machine learning model 313 may have a trigger for retraining. In one embodiment, ingestion of new data, such as user data, third-party data, interaction data, or financial instrument data, may trigger retraining or fine tuning of machine learning model 313. In some embodiments, machine learning model 313 may be trained using historical data, including historical trust data, and may continuously adjust internal parameters. In some embodiments, machine learning model 313 may be validated using separate datasets to assess accuracy, precision, recall, and other metrics. In some embodiments, machine learning model 313 may be evaluated through cross-validation or confusion matrices. Machine learning model 313 may be able to output a variety of data including scores, classifications, or recommendations. Machine learning model 313 may be configured to accept a variety of inputs, including text, image, audio, time series inputs, categorical inputs, and numerical inputs.

Memory 314 may include one or more storage devices configured to store instructions used by processor 311 to perform functions related to a computing device. The disclosed embodiments are not limited to software programs or devices configured to perform dedicated tasks. For example, memory 314 may store a single program, such as a user-level application, which may perform the functions associated with the disclosed embodiments or may include multiple software programs. Additionally, processor 311 may, in some embodiments, execute one or more programs (or portions thereof) remotely located from smart risk server 204. Furthermore, memory 314 may include one or more storage devices configured to store data for use by the programs. Memory 314 may include, but is not limited to, a hard drive, a solid-state drive, a CD-ROM drive, a peripheral storage device (e.g., an external hard drive, a USB drive, etc.), a network drive, a cloud storage device, or any other storage device.

Smart risk server 204 may include one or more digital and/or analog devices that allow communication with other machines and devices, such as other components of a smart risk analysis lending platform. Smart risk server 204 may include one or more input devices 315 and one or more output devices 316. Input device 315 may be configured to receive input from a user, and one or more components of smart risk server 204 may perform one or more functions in response to the input received. In some embodiments, input device 315 may include a user interface, displayed on a touchscreen (an exemplary output device 316). Output device 316 may include a screen for displaying communications to a user. For example, output device 316 may include a display configured to display the information relating to the transaction. Smart risk server 204 may include other components known in the art for interacting with a user. Output device 316 may also include a digital and/or analog device that allows a user to interact with the smart risk analysis lending platform 200, such as touch sensitive area, keyboard, buttons, or microphones.

In some embodiments, smart risk server 204 may include database 317. Database 317 may be included on a volatile or non-volatile, magnetic, semiconductor, tape, optical, removable, non-removable, or other type of storage device or tangible or non-transitory computer-readable medium. Database 317 may also be part of smart risk server 204 or separate from smart risk server 204. When database 317 is not part of smart risk server 204, smart risk server 204 may exchange data with database 317 via a communication link. Database 317 may include a memory device that stores data and instructions used to perform a features of the disclosed embodiment. Database 317 may include any suitable databases, ranging from small databases hosted on a workstation to large databases distributed among data centers. Database 317 may also include any combination of databases controlled by memory controller devices (e.g., server(s)) or software. For example, database 317 may include document management systems, Microsoft SQL™ databases, SharePoint™ databases, Oracle™ databases, Sybase™ databases, other relational databases, or non-relational databases, such as mongo and others.

FIG. 4 depicts a flow chart for a method of calculating a risk assessment score. Some embodiments pertain to calculating a user's trustworthiness score based on financial, non-financial, and financial-adjacent activity. Such embodiments may involve a computer system, for example, at a bank or institution, that calculates a user's trustworthiness score based on financial, non-financial, and financial-adjacent activity. Method 400 may include a step 401 of receiving user data into a database. In some embodiments, the user data may be received into the database based on the user data matching criteria directed to identifying the user data as indicating either user activity or user inactivity. The criteria may help in determining if the user data is directed to the user activity, user inactivity, or neither and may restrict user data that is not relevant from being received and processed. In some embodiments, the criteria may involve time-based filtering to identify data generated during a period of time when the user activity and the user inactivity are most likely to occur. In some embodiments, the criteria may involve location-based filtering to identify data generated in a location where the user activity and the user inactivity are most likely to occur. In some embodiments, the criteria may involve schema matching, where the database may filter for data structures or types of user data most often related to user activity and user inactivity. In some embodiments, the criteria may involve keyword matching and may scan the user data, for identifiers associated with the data that may classify the data as, for example, a login or a purchase. In some embodiments, the criteria may involve user identifier matching to track the user data by, for example, an internet protocol address, cookies, user identifications, or session tokens.

User activity, as described herein, may refer to an affirmative action taken by the user, such as, for example, making a payment, making a payment late, registering for or attending an event, gambling, volunteering, making a donation, driving over or under the speed limit, arriving on time, arriving late, or paying back a friend. User inactivity, as described herein may refer to a lack of action by the user in situations where action may be generally favorable, such as, for example, the user failing to make a payment, registering for an event but not attending, or not paying another user back. In some embodiments, the user data may include, for example, personally identifying information, transaction information, account information, credit and risk information, or behavioral and usage information. In some embodiments, the user data may include additional information volunteered to the institution by the user that may provide a fuller picture of who the user is, such as, for example, letters or recommendation or testimonial statements. In some embodiments, data besides user data, such as third-party data, user interaction data, financial instrument data, or external user data, may be received into the database.

Method 400 may include a step 402 of partitioning the user data in the database. The partition may be configured to separate out the user data indicating the user activity or the user inactivity, based on the criteria. In some embodiments, data besides user data, such as third-party data, user interaction data, financial instrument data, or external user data, may be partitioned. Partitioning, as described herein, may refer to identifying and separating relevant pieces of information from a larger set of information. Partitioning, as described herein, may involve grouping data according to common attributes. In some embodiments, partitioning may involve horizontal partitioning. Horizontal partitioning, as described herein, may refer to grouping data based on a specific rule. For example, a dataset having user data from several users may be grouped based on a range of user identification numbers so that users with a last name starting with the letter A through the letter M are in one group, and users having the last name starting with the letter N through the letter Z are in another group. In another example, user data may be grouped based on a user activity identification number. The user activity identification number, as described herein, may be a code assigned to user activity or user inactivity by an institution to identify user data as involving the user activity. For example, user activity involving a withdrawal of funds may have one user activity identification number, and user activity involving a deposit of funds may have another user activity identification number. The partition may separate the user data into groups based on the user activity identification number. In another example, the user data may be partitioned to group user data having a user activity identification number indicating user activity in one group and group user data having a user activity identification number indicating user inactivity in another group. In some embodiments, horizontal partitioning may involve grouping user data from a first period of time in one group and storing user data from a second period of time in another group.

In some embodiments, partitioning may involve vertical partitioning. Vertical partitioning, as described herein, may refer to separating an entry of user data into two or more groups so that a subset of fields for an entry is in one group and other subsets for the entry are in another group. For example, the user data may include transaction information including a record of purchases made in January. The transaction information may include the user activity identification number, the date and time, the location, the merchant name, the cost, and what was purchased. The vertical partition may separate the transaction so that the user activity identification number, the date and time, and the cost may be put into one group, and the merchant name, the location, and what was purchased may be put into another group.

In some embodiments, partitioning may involve functional partitioning. Functional partitioning, as described herein, may refer to separating out user data into groups based on how a system or platform may use the user data or based on the user data having a common attribute or goal. For example, functional partitioning may involve separating user data so that user data involving personally identifying information is put in one group and user data involving transaction information is put in another group.

Method 400 may include a step 403 of filtering the partitioned user data based on a category of user activity. Filtering, as described herein, may refer to sorting, categorizing, organizing, or migrating pieces of data from a larger set into smaller groups. The category of user activity, as described herein, may be one of financial activity, non-financial activity, or financial-adjacent activity, as described with respect to FIG. 2. In some embodiments, the category of user activity may be more specific to the user activity and the user inactivity. For example, the category of user activity may include account management, payments, account maintenance, or interaction data. In some embodiments, filtering may involve query filtering. Query filtering, as described herein, may involve applying logical conditions such as “where,” “or,” and “and” to select user data that matches criteria, such as selecting from transaction data the transactions occurring in Town T, or selecting user data matching a user activity identification number. In some embodiments, the user activity identification number may be identifiable as user activity that is one of either financial activity, non-financial activity, or financial adjacent activity.

In some embodiments, filtering may involve value-based filtering. Value-based filtering, as described herein, may involve keeping or discarding user data based on a value, range, or threshold. For example, value-based filtering may involve discarding user data older than thirty days old. In some embodiments, filtering may involve content-based filtering. Content-based filtering, as described herein, may use keywords to sort, categorize, organize, or migrate pieces of data from a larger set into smaller groups. In some embodiments, data besides partitioned user data, such as partitioned third-party data, partitioned user interaction data, partitioned financial instrument data, or partitioned external user data, may be filtered.

Method 400 may include a step 404 of classifying, using a machine learning model, the partitioned user data as high value, intermediate value, or low value. The machine learning model may be trained, using historical user data and historical classifications, to recognize an impact of the user activity or the user inactivity on a perceived trustworthiness of a user, as described with respect to FIG. 2.

The training may involve assessing a likelihood that the user activity or the user inactivity indicates that a user is more or less trustworthy than a previous trustworthiness assessment based on the historical user data and the historical classifications. The training may involve comparing the new user activity or user inactivity to the user's historical activities or in-activities to determine how the new activity or inactivity impacts a trustworthiness assessment. For example, the user may have previously been assessed as trustworthy based on returning their library books on time. A new instance of returning a library book on time may reinforce the evaluation of trustworthiness but may have a limited incremental impact on the evaluation of trustworthiness. Meanwhile, a new user activity indicating that the previous returns on time were fraudulent may have a significant impact on the evaluation of trustworthiness.

The training may further involve assigning a value of high value, intermediate value, or low value, based on the likelihood. The high, intermediate, or low value may be assigned based on the relationship of the activity to financial activity, as described herein. In some embodiments, the value may be assigned based on a relationship between the user activity or inactivity and potentially fraudulent conduct, as in the example of previous on-time returns being fraudulent. The training may further involve evaluating the assignment based on an evaluation criteria. As described herein, the evaluation against evaluation criteria may involve checking the accuracy of the model's prediction based on a known or provided value in a training dataset. The evaluation criteria may be a rubric, including a numerical rubric, designed to evaluate the accuracy of the model's determinations across a range of input data. The training may further involve revising the assignment into a classification as high value, intermediate value, or low value based on the evaluation. In some embodiments, the evaluation may indicate that further training of the model is required after revising the assignment. In some embodiments, as described herein, retraining may be performed periodically to account for updated data, incorporate new evaluation criteria, and/or assess the validity of the model's results for, e.g., bias in the model's results.

Method 400 may include a step 405 of assigning a weight to the partitioned user data based on the category of user activity and the classification. The weight may indicate a significance of the user activity or the user inactivity. Weight, as described herein, may refer to a qualitative factor or a quantitative factor for indicating value or significance of the user data. In some embodiments, the qualitative factor may be descriptive, such as light and heavy or weak and strong, where the qualitative factor may be a binary determination. In such a binary determination, light and weak may indicate the partitioned user data, including user activity, may not be significant, while heavy and strong may indicate that the user data may be significant.

In some embodiments where the weight is a quantitative factor, the weight may be a numerical multiplier. In some embodiments, the numerical multiplier may be predetermined by an institution. In other embodiments, the numerical multiplier may be selected or adjusted based on historical trust data. The historical trust data may highlight which category of user activity was most significant for determining trustworthiness of the user in the past and provide insight into how the relative importance of the category of user activity may change. For example, the historical trust data may reveal that while financial activity was most important for determining trustworthiness of the user last year, financial adjacent activity is becoming increasingly important for determining trustworthiness of the user. In some embodiments, the numerical multiplier may be a value less than or equal to one, where the sum of the numerical multipliers for the category of user activity is equal to one. In some embodiments, the numerical multipliers for the category of user activity may not sum to one. In some embodiments, the numerical multiplier may be a value greater than one. Significance, as described herein, may refer to a relative importance of user activity and may be indicated by way of, for example, a numerical multiplier or descriptive language.

In some embodiments, financial activity may be given a heavier weight than non-financial activity. In some embodiments, financial-adjacent activity may be assigned a greater weight than non-financial activity but a lesser weight than financial activity. In some embodiments, the weight may be proportional to a likelihood that the user activity indicates trust or risk, such that the user activity that better reflects a user's trustworthiness or risk aversion may be assigned a weight greater than user activity that does not reflect a user's trustworthiness as well.

Method 400 may include a step 406 of calculating, using a statistical trust model, a risk assessment score. The statistical trust model may be configured to predict trustworthiness of the user by summing a base risk assessment score and an impact associated with the user activity or user inactivity, where the impact is a product of a nonlinear, time-weighted penalty curve function and the weight, as described with respect to FIG. 2. In some embodiments, the risk assessment score may be displayed on an account. In some embodiments, the risk assessment score may be a numerical score. In some embodiments, the numerical score may be assigned a descriptive classifier such as, for example, good or bad.

In some embodiments, the risk assessment score may be used to advise the institution and its representatives on how trustworthy the user may be and how likely the user may be to repay borrowed money on time to help the institution decide whether to approve the user's application for a financial instrument and what terms to offer the user.

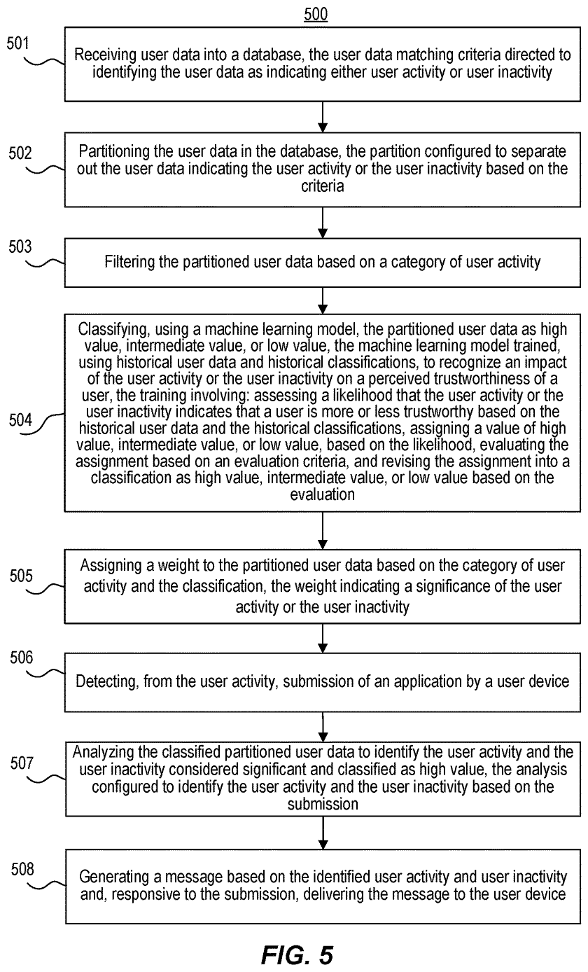

FIG. 5 depicts a flow chart for a method of providing application feedback to a user. Some embodiments pertain to an alternative lending solution that provides users with options for improving the likelihood of their loan or credit card applications being accepted. Such embodiments may involve a computer system, for example, at a bank or institution, having an alternative lending solution that provides users with options for improving the likelihood of their loan or credit card applications being accepted.

Method 500 may include a step 501 of receiving user data into a database. The user data may match criteria directed to identifying the user data as indicating either user activity or user inactivity, as described with respect to FIG. 4.

Method 500 may include a step 502 of partitioning the user data in the database. The partition may be configured to separate out the user data indicating the user activity or the user inactivity, based on the criteria, as described with respect to FIG. 4. Method 500 may include a step 503 of filtering the partitioned user data based on a category of user activity, as described with respect to FIG. 4. In some embodiments, the category of user activity may be one of financial activity, financial-adjacent activity, or non-financial activity, as described with respect to FIG. 2.

Method 500 may include a step 504 of classifying, using a machine learning model, the partitioned user data as high value, intermediate value, or low value. The machine learning model may be trained, using historical user data and historical classifications, to recognize an impact of the user activity or the user inactivity on a perceived trustworthiness of a user, as described with respect to FIG. 2. The training may involve assessing a likelihood that the user activity or the user inactivity indicates that a user is more or less trustworthy based on the historical user data and the historical classifications. The training may further involve assigning a value of high value, intermediate value, or low value, based on the likelihood. The training may further involve evaluating the assignment based on an evaluation criteria. The training may further involve revising the assignment into a classification as high value, intermediate value, or low value based on the evaluation.

Method 500 may include a step 505 of assigning a weight to the partitioned user data based on the category of user activity and the classification. The weight may indicate a significance of the user activity or the user inactivity, as described with respect to FIG. 4. In some embodiments, the weight may be a numerical multiplier, as described with respect to FIG. 4. In some embodiments, financial activity may be assigned a greater weight than non-financial activity. In some embodiments, financial-adjacent activity may be assigned a greater weight than non-financial activity but a lesser weight than financial activity. In some embodiments, the weight may be proportional to a likelihood that the user activity indicates trust or risk such that the category of user activity that better reflects trustworthiness or risk aversion of the user may be assigned a weight greater than another category of activity that does not reflect the trustworthiness of the user as well.

Method 500 may include a step 506 of detecting, from the user activity, submission of an application by a user device. Application, as described herein, may refer to a credit application, loan application, credit card application, a mortgage application, or some other application for funds or a financial instrument. Detecting submission of one or more applications may involve gathering and analyzing institution records. Detecting may involve performing a keyword search or database query on institution records. In some embodiments, institution records may be filtered based on a time constraint or based on relevance.

Method 500 may include a step 507 of analyzing the classified partitioned user data to identify the user activity and the user inactivity considered significant and classified as high value. In some embodiments, the analysis may be configured to identify the user activity and the user inactivity based on the submission. In some embodiments, the analysis may involve the use of logical tests, such as determining whether a condition is true or false. In one example, the category of user activity may be one of financial activity, non-financial activity, or financial-adjacent activity. In some embodiments, when the application is a credit card application, the analysis may focus on classified partitioned user data related to spending and repayment. In some embodiments, when the application is a loan application or a mortgage application, the analysis may focus on classified partitioned user data related to repayment and savings. The partitioned user data may include that the user uses a mobile device to access a user account, which may be a financial account, twice per week; the user works as a veterinarian's assistant; and the user purchased a television from Retailer R. The user checking their account twice per week may be classified as high value, the user working as a veterinarian's assistant may be classified as intermediate value, and the user purchasing a television may be classified as low value.

Further, the user checking their account twice per week may be recognized as falling into the category of financial-adjacent activity, the user working as a veterinarian's assistant may be recognized as falling into the category of non-financial activity, and the user purchasing a television may be recognized as falling into the category of financial activity. The partitioned user data may be assigned the weight based on the category of user activity, and, from the weight, the categories of financial activity and financial-adjacent activity may be considered significant. The analysis may involve performing a first logical test to determine which partitioned user data, including user activity, may be significant. The partitioned user data where this condition is true may be the user using a mobile device to access a user account and the user purchasing the television.

The analysis may then perform a second logical test to determine which partitioned user data, from results of the first logical test, may be high value. The partitioned user data where this condition is true may be the user using a mobile device to access a user account twice per week. Thus, partitioned user activity that may be significant and high value may include the user using a mobile device to access a user account twice per week. In some embodiments, only one user activity may be deemed significant. In some embodiments, the non-financial activity may be deemed significant. In some embodiments, each category of user activity may include partitioned user data classified as low value, partitioned user data classified as intermediate value, and partitioned user data classified as high value.

In some embodiments, the analysis may identify a different combination of one of either low value, intermediate value, and high value, and one of significant, not significant, or a threshold significance, such as a range of numerical multipliers. For example, the analysis may identify partitioned user data falling into a category of user activity considered significant and classified as low value. In some embodiments, the analysis may identify partitioned user data falling into a category of user activity assigned, as a weight, a numerical multiplier of greater than 0.3 and classified as intermediate value.

Method 500 may include a step 508 of generating a message based on the identified user activity and user inactivity and, responsive to the submission, delivering the message to the user device. Messages may include account updates or reminders, feedback, incentives, reports, polls, notices, cautions, invitations, offers, promotions, discounts, or informative materials and may be delivered via text message, push notification, email, phone call, fax, direct message, or to a user account. In some embodiments, the message may include an example of user activity that a user should cease to improve a chance of the application being approved. In some embodiments, the message may include an example of user activity that a user should engage in to improve the chance of the application being approved. For example, the user activity or user inactivity considered significant and classified as high value that was identified during the analysis may be included in the message as an example of user activity the user should engage in to improve the chance of the application being granted.

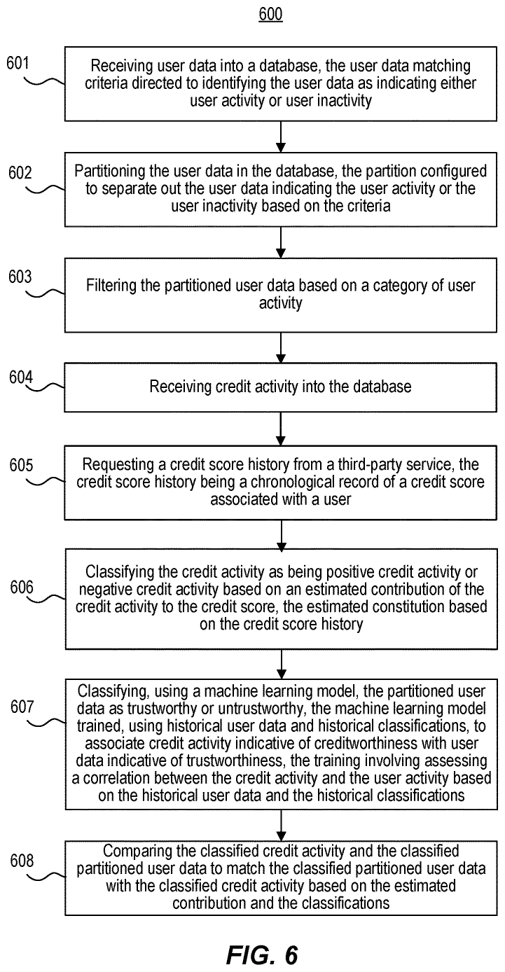

FIG. 6 depicts a flow chart for a method of mapping creditworthiness to trustworthiness. Some embodiments pertain to a machine learning model that maps good credit in the traditional sense to trustworthiness in an alternative approach. Such embodiments may involve a computer system, for example, at a bank or institution, that uses a machine learning model to map good credit in the traditional sense to trustworthiness in an alternative approach.

Method 600 may include a step 601 of receiving user data into a database. The user data may match criteria directed to identifying the user data as indicating either user activity or user inactivity, as described with respect to FIG. 4. Method 600 may include a step 602 of partitioning the user data in the database. The partition may be configured to separate out the user data indicating the user activity or the user inactivity, based on the criteria, as described with respect to FIG. 4. Method 600 may include a step 603 of filtering the partitioned user data based on a category of user activity, as described with respect to FIG. 4. In some embodiments, the category of user activity may be one of financial activity, financial-adjacent activity, or non-financial activity, as described with respect to FIG. 2.

Method 600 may include a step 604 of receiving credit activity into the database. Credit activity, as described herein, may refer to activity related to borrowing money or using credit and activity related to interactions with creditors and lenders. Such activity may include payment history, such as whether the user made payments and when those payments were made; amounts owed, such a total debt of a user and a user's credit utilization ratio; a length of a user's credit history, such as an age of a user's oldest credit account, the age of a user's newest credit account, and an average age of all of a user's credit accounts; a user's credit mix, such as what quantities and types (for example, credit card, mortgage, and auto loan) of credit accounts the user has; and a user's new credit, such as how many new credit accounts the user has opened and how many credit inquiries the user has made within the last year, for example. In some embodiments, the credit activity may be subset of the user data and may be retrieved from a user account for storage in the database. In some embodiments, the data may be retrieved through querying or through keyword searches. In some embodiments, the credit activity may be filtered based on a time constraint or based on relevance.

Method 600 may include a step 605 of requesting a credit score history from a third-party service, the credit score history being a chronological record of a credit score associated with a user. The credit score history may be an ordered list or graphical representation of the credit score over time. For example, the credit score history may textually relay or visually illustrate, such as with a line graph, that the credit score was 731 on the first day of January, 746 on the first day of February, and 713 on the first day of March. In some embodiments, credit activity may be gathered and sent to the third-party service for processing into the credit score, and a request may be made to receive the credit score after processing. In some embodiments, the request may involve use of an application program interface (API). The API may facilitate data flow between the institution and the third-party service such that the institution relays credit activity to the third-party service, the third-party service processes the credit activity to formulate the credit score, and the third-party service returns the processed credit activity in the form of the credit score for a period of time.

Method 600 may include a step 606 of classifying the credit activity as positive credit activity or negative credit activity based on an estimated contribution of the credit activity to the credit score. In some embodiments, the estimated contribution may be based on the credit score history. Positive credit activity, as described herein, may refer to credit activity indicative of creditworthiness. Negative credit activity, as described herein, may refer to activity indicative of a lack of creditworthiness. In some embodiments, the estimated contribution may be based on a credit formula of the third-party service. A credit formula, as described herein, may refer to a proprietary formula used to process the credit activity into the user's credit score. In some embodiments, the credit formula may be used to simulate how credit activity may impact the user's credit score to estimate the contribution of the credit activity to the user's credit score. In some embodiments, the estimated contribution may be based on the credit score history by observing the credit score before and after credit activity to identify how credit activity impacted the credit score.

Method 600 may include a step 607 of classifying, using a machine learning model, the partitioned user data as trustworthy or untrustworthy. The machine learning model may be trained, using historical user data and historical classifications, to associate credit activity indicative of creditworthiness with user data indicative of trustworthiness. The training may involve assessing a correlation between the credit activity and the user activity based on the historical user data and the historical classifications.

The machine learning model, as described with respect to FIG. 2 and further described herein, may be used to classify partitioned user activity as trustworthy or untrustworthy. For example, the machine learning model may be trained from historical trust data, including historical user data and historical classifications. The historical user data may include user activity and user inactivity, as well as whether the user activity or user inactivity indicates trustworthiness or untrustworthiness. The historical trust data may be data from a period of time, such as one month or one year, prior to present day. In some embodiments, the machine learning model may be trained to recognize that user activity involving the user being reliable and consistent, accountable and honest, the user having integrity and being ethical, and the user being transparent and cooperative may generally indicate trustworthiness. Thus, user activity involving reliability and consistency, accountability and honesty, interpersonal integrity, ethical conduct, or transparency and cooperation should generally be classified as trustworthy. In some embodiments, the machine learning model may also be trained to associate credit activity indicative of creditworthiness with the partitioned user data indicative of trustworthiness.

In some embodiments, the machine learning model may be trained from user data, including user activity and user inactivity. The machine learning model may be input user activity or user inactivity, such as a user's transactions and when the transactions were made, the user's involvement with third parties, or information about the user or the user's relationships. For example, the machine learning model may receive user activity and user inactivity showing that the user always pays off their credit card balance one week before the payment is due, the user called the institution shortly after receiving notice of a potential fraudulent charge on the user's credit card, and the user works as an investment professional managing other people's money.

During training, the machine learning model may be trained that user activity involving repeated behavior indicates consistency and reliability, which likely indicate trustworthiness. For example, when the user pays off their credit card balance one week before the payment each month, the machine learning model may learn that the user is behaving consistently and reliably, which may indicate that the user is trustworthy. The machine learning model may learn that, since the user paying off their credit card one week before the payment is due each month may be consistent and reliable behavior, the partitioned user data should be classified as trustworthy.

Similarly, the machine learning model may learn that user activity involving user engagement and responsiveness with the institution indicates cooperation and are likely indicative of trustworthiness. For example, when the user calls back the institution shortly after receiving notice of a potential fraudulent charge on the user's credit card, the machine learning may learn that the user promptly calling back an institution after being notified of a potential fraudulent charge shows cooperation and responsibility which are likely indicative of trustworthiness. So, the machine learning model may learn that, since the user calling the institution back shortly after receiving notice of a possible fraudulent charge may show cooperation and responsibility, the partitioned user data should be classified as trustworthy.

Similarly, the machine learning model may be trained that user activity involving the user acting in the best interest of others indicates honesty and integrity and is likely indicative of trustworthiness. For example, when the user is employed as an investment professional and manages other people's money, the machine learning may learn that the user working in a role where they are responsible for people or businesses' money shows that the user likely acts with honesty and integrity, which are likely indicative of trustworthiness. So, the machine learning model may learn that, since the user being employed to manage others' money may show honesty and integrity, the partitioned user data should be classified as trustworthy.

The machine learning model may learn from the examples and go through further training of receiving partitioned user data, including user activity, for a period of time and classifying the partitioned user data as trustworthy or untrustworthy. For each piece of partitioned user data, including user activity and user inactivity, the machine learning model may assess whether the user activity is likely to indicate trustworthiness or untrustworthiness and classify the partitioned user data as either trustworthy or untrustworthy. The classification may then then be confirmed or corrected until the machine learning model is able to make accurate determinations a threshold amount of the time.

For example, the machine learning model may receive partitioned user data, including user activity and user inactivity, including that the user has been one day late on their credit card payment every month for the last four months, the user changed a password shortly after receiving notice of a suspicious login attempt, and the user was investigated for insider trading. The machine learning model may determine that the user making their credit card payment one day late for four months in a row shows consistency. The machine learning model may recognize that user activity showing consistency is generally indicative of trustworthiness, and the machine learning model may thus classify the partitioned user data as trustworthy. The machine learning model may be informed that its classification was incorrect. The machine learning model may learn that while consistency may generally be indicative of trustworthiness, some user activity that is consistent, such as user activity involving consistently making late payments, is indicative of untrustworthiness. After the machine learning model is corrected, the machine learning model may continue training with additional examples.

In another example, the machine learning model may determine that the user changing a password shortly after receiving notice of a suspicious login attempt shows responsibility and proactivity. The machine learning model may recognize that user activity involving responsibility and proactivity is indicative of trustworthiness, and the machine learning may thus classify the partitioned user data as trustworthy. The machine learning model may be informed that its classification is correct and continue training with additional examples.

In another example, the machine learning model may determine that the user being investigated for insider trading shows dishonesty and unethical conduct. The machine learning model may recognize that user activity involving dishonesty and unethical conduct is generally indicative of untrustworthiness, and the machine learning model may thus classify the partitioned user data as untrustworthy. The machine learning model may be informed that its classification is correct and continue training with additional examples.

The machine learning model may be configured to accept specific inputs. For example, the machine learning model may receive partitioned user data, including user activity and user inactivity. In some embodiments, the machine learning model may receive and classify other data, such as third-party data or interaction data. The machine learning model may receive the partitioned user data, recognize whether the user activity or the user inactivity is indicative of trustworthiness, and classify the partitioned user data as either trustworthy or untrustworthy.

Method 600 may include a step 608 of comparing the classified credit activity and the classified partitioned user data to match the classified partitioned user data with the classified credit activity based on the estimated contribution and the classification. In some embodiments, comparing may involve mapping the classified credit activity to the classified partitioned user data. Mapping, as described herein, may refer to transforming datapoints or data sets into comparable forms for analysis and processing. In some embodiments, comparing may involve concluding that user activity or user inactivity having a quality is somewhat trustworthy or very trustworthy. Quality, as described herein, may refer to a characteristic of the user implicated by the user activity or the user inactivity, such as reliability and consistency, accountability and honesty, responsibility and proactivity, interpersonal integrity, ethical conduct, and transparency and cooperation. Similarly, comparing may involve concluding that user activity or user inactivity having a quality is somewhat untrustworthy or very untrustworthy. In some embodiments, the conclusions may be predetermined.

For example, comparing may involve concluding that user activity showing a user is consistent and reliable is considered somewhat trustworthy, and user activity showing a user is inconsistent and unreliable is considered somewhat untrustworthy. Comparing may then involve concluding that user activity showing a user is honest and ethical is considered very trustworthy, and user activity showing a user is dishonest and unethical is considered very untrustworthy.

Comparing may then involve determining, from the credit score history and the estimated contribution of the credit activity, that positive credit activity is somewhat positive credit activity or very positive credit activity and that negative credit activity is somewhat negative credit activity or very negative credit activity. For example, comparing may involve determining that positive credit activity having an estimated contribution of raising the user's credit score by zero to twenty points may be considered somewhat positive credit activity, and positive credit activity having an estimated contribution of raising the user's credit score by more than twenty points may be considered very positive credit activity. Similarly, comparing may involve determining that negative credit activity having an estimated contribution of lowering the user's credit score by zero to twenty points may be considered somewhat negative credit activity, and negative credit activity having an estimated contribution of lowering the user's credit score by more than twenty points may be considered very negative credit activity.

In some embodiments, the positive credit activity may be correlated with user activity classified as trustworthy, and the negative credit activity may be correlated with user activity classified as untrustworthy. Somewhat positive credit activity may be deemed similar to user activity or user inactivity considered somewhat trustworthy, very positive credit activity may be deemed similar to user activity or user inactivity considered very trustworthy, somewhat negative credit activity may be deemed similar to user activity or user inactivity considered somewhat untrustworthy, and very negative credit activity may be deemed similar to user activity or user inactivity considered very untrustworthy. For example, the estimated contribution of negative credit activity involving the user making a payment one day late and never having made a late payment before may be a decrease of fifteen points in the user's credit score. The negative credit activity may then be determined to be somewhat negative credit activity since the negative credit activity resulted in a decrease of less than or equal to twenty points. The partitioned user data may include user activity including that the user often arrives late to work. The user activity indicated that the user may be inconsistent and unreliable, so the user activity may be considered somewhat untrustworthy. Thus, the credit activity of the user making a payment one day late and the user often arriving late to work may be considered to be a match. In some embodiments, matching classified partitioned user data considered trustworthy with the classified credit activity considered positive credit activity may be considered a positive match. In some embodiments, matching classified partitioned user data considered untrustworthy with the classified credit activity considered negative credit activity may be considered a negative match. In some embodiments, the comparison may result in a determination of whether there are more positive matches or negative matches. In such embodiments, the user may be prompted to sign up for a smart risk analysis lending platform when there are more positive matches than negative matches.

In some embodiments, from determining which classified partitioned user data matches the classified credit activity, the comparison may result in an estimation of whether a risk assessment score associated with the user may be better than the credit score. Better, as described herein, may mean the risk assessment score may be numerically greater in value than the credit score. In some embodiments, the estimation of whether the risk assessment score associated with the user may be better than the credit score may be delivered to a user device. In some embodiments, the estimation may be delivered via text message, email, or push notification. In some embodiments, when the estimation results in a determination that the risk assessment score is better than the credit score, the user may be prompted to sign up for a smart risk analysis lending platform to claim the user's risk assessment score.

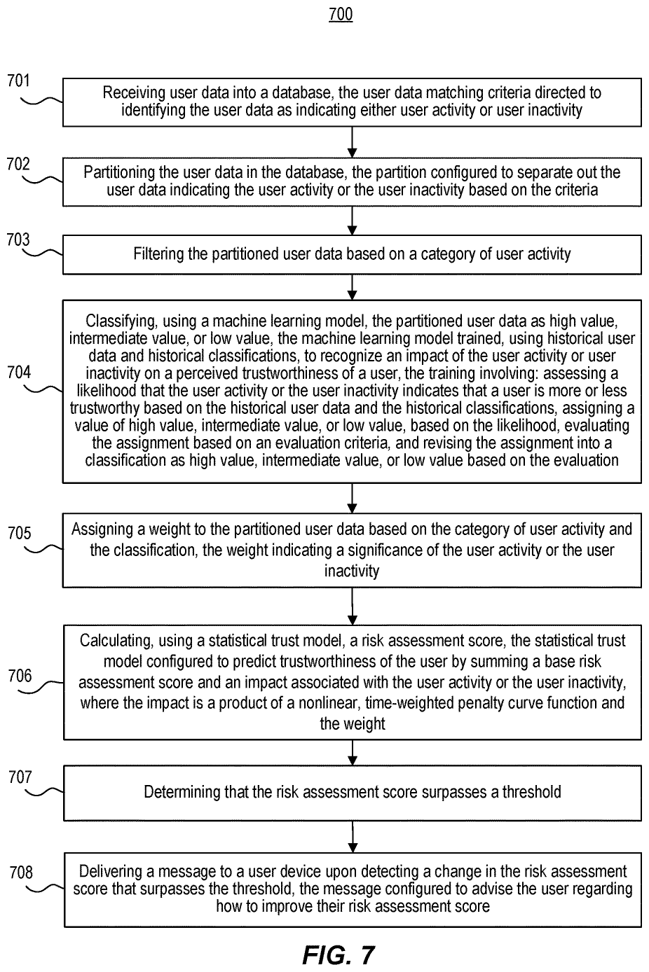

FIG. 7 depicts a flow chart for a method of providing trustworthiness feedback to a user. Some embodiments pertain to a machine learning model that provides users with feedback on how to improve their trustworthiness score. Such embodiments may involve a computer system, for example, at a bank or institution, that uses a machine learning model to provide users with feedback on how to improve their trustworthiness score.

Method 700 may include a step 701 of receiving user data into a database. The user data may match criteria directed to identifying the user data as indicating either user activity or user inactivity, as described with respect to FIG. 4. Method 700 may include a step 702 of partitioning the user data in the database. The partition may be configured to separate out the user data indicating the user activity or the user inactivity, based on the criteria, as described with respect to FIG. 4. Method 700 may include a step 703 of filtering the partitioned user data based on a category of user activity, as described with respect to FIG. 4. In some embodiments, the category of user activity may be one of financial activity, financial-adjacent activity, or non-financial activity, as described with respect to FIG. 2.

Method 700 may include a step 704 of classifying, using a machine learning model, the partitioned user data as high value, intermediate value, or low value. The machine learning model may be trained, using historical user data and historical classifications, to recognize an impact of the user activity or the user inactivity on a perceived trustworthiness of a user, as described with respect to FIG. 2. The training may involve assessing a likelihood that the user activity or the user inactivity indicates that a user is more or less trustworthy based on the historical user data and the historical classifications. The training may further involve assigning a value of high value, intermediate value, or low value, based on the likelihood. The training may further involve evaluating the assignment based on an evaluation criteria. The training may further involve revising the assignment into a classification as high value, intermediate value, or low value based on the evaluation.

Method 700 may include a step 705 of assigning a weight to the partitioned user data based on the category of user activity and the classification. The weight may indicate a significance of the user activity or the user inactivity, as described with respect to FIG. 4. In some embodiments, the weight may be a numerical multiplier, as described with respect to FIG. 4. In some embodiments, the category of user activity of financial activity may be assigned a greater weight than the weight assigned to the category of user activity of non-financial activity. In some embodiments, the weight may be proportional to a likelihood that the user activity indicates trust or risk such that the category of user activity that better reflects trustworthiness or risk aversion of the user may be assigned a weight greater than another category of activity that does not reflect the trustworthiness of the user as well.

Method 700 may include a step 706 of calculating, using a statistical trust model, a risk assessment score. The statistical trust model may be configured to predict trustworthiness of the user by summing a base risk assessment score and an impact associated with the user activity or the user inactivity, where the impact is a product of a nonlinear, time-weighted penalty curve function and the weight, as described with respect to FIG. 2. In some embodiments, the risk assessment score may be a numerical score. In some embodiments, the risk assessment score may be used to advise the institution and its representatives on how trustworthy the user may be and how likely the user may be to repay borrowed money on time to help the institution decide whether to approve the user's application for a financial instrument and what terms to offer the user.

Method 700 may include a step 707 of determining that the risk assessment score surpasses a threshold. The message may be configured to advise the user how to improve the risk assessment score. Threshold, as described herein, may refer to a risk assessment score value at which the risk assessment score changes, for example, between a bad risk assessment score and good risk assessment score. In some embodiments, the threshold may be a predetermined score threshold, wherein the predetermined score threshold may divide a range of risk assessment scores into two or more groups. In some embodiments, the groups may be the same size and in other embodiments the groups may be different sizes. For example, in one embodiment, the risk assessment score may be a value between 0 and 300. The predetermined score threshold may be 150 and divide the range of risk assessment scores into two groups, one ranging from 0 to 150 and one ranging from 151 to 300. In some embodiments, a risk assessment score that has a value between 0 and 150 may be a bad risk assessment score, and a risk assessment score that has a value between 151 and 300 may be a good risk assessment score. In some embodiments, there may be two predetermined score thresholds. A first predetermined score threshold may be 100 and a second predetermined score threshold may be 200, dividing the range of risk assessment scores into three groups, one group ranging from 0 to 100, a second group ranging from 101 to 200, and a third group ranging from one ranging from 201 to 300.

Method 700 may include a step 708 of delivering a message to a user device upon detecting a change in the risk assessment score that surpasses the threshold. The message may be configured to advise the user regarding how to improve the risk assessment score. In some embodiments, the message may be based on whether the risk assessment score is greater than the predetermined score threshold. The message may provide notice to the user that the risk assessment score has exceeded or dropped below a threshold. For example, in an example where the risk assessment score is a numerical score having a value between 0 and 300 with one predetermined score threshold at 150, if the user's risk assessment score changes from 133 to 161, the user may receive a message, the user may receive a message including that the user's risk assessment score increased 28 points and the user's risk assessment score is now considered a good risk assessment score. In some embodiments, the message may be delivered via text message, push notification, email, phone call, fax, direct message, or to a user account. In some embodiments, the message may include an example of user activity that the user should engage in to improve the user's risk assessment score. In some embodiments, the message may include an example of user activity that the user should avoid to improve the user's risk assessment score.

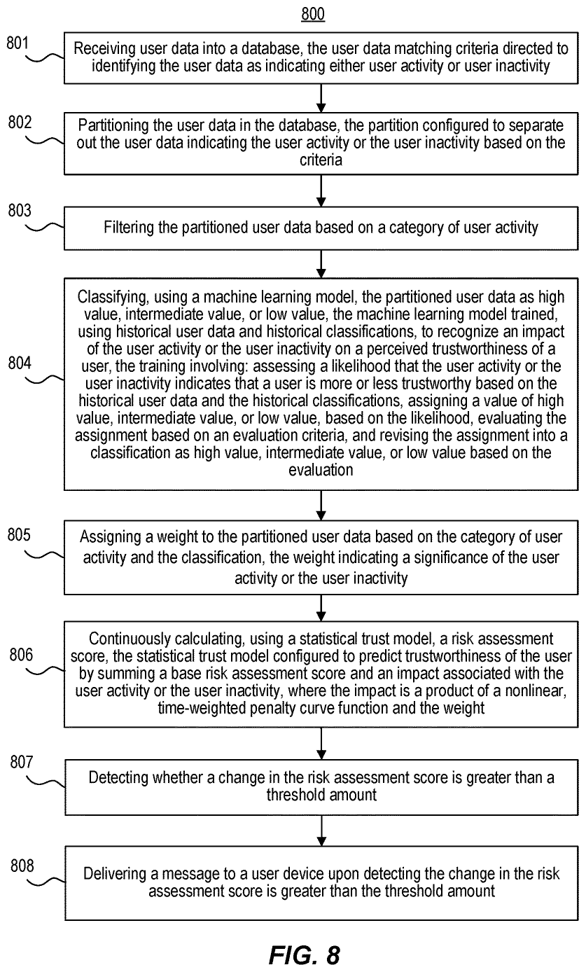

FIG. 8 depicts a flow chart for a method of providing feedback to a user. Some embodiments pertain to pushing feedback notifications to users congratulating them or issuing a warning when their trustworthiness score increases or decreases past a certain threshold. Such embodiments may involve a computer system, for example, at a bank or institution, that pushes feedback notifications to users congratulating them or issuing a warning when their trustworthiness score increases or decreases past a certain threshold.

Method 800 may include a step 801 of receiving user data into a database. The user data may match criteria directed to identifying the user data as indicating either user activity or user inactivity, as described with respect to FIG. 4. Method 800 may include a step 802 of partitioning the user data in the database. The partition may be configured to separate out the user data indicating the user activity or the user inactivity, based on the criteria, as described with respect to FIG. 4. Method 800 may include a step 803 of filtering the partitioned user data based on a category of user activity. In some embodiments, the category of user activity may be one of financial activity, financial-adjacent activity, or non-financial activity, as described with respect to FIG. 2. Method 800 may include a step 804 of classifying, using a machine learning model, the partitioned user data as high value, intermediate value, or low value. The machine learning model may be trained, using historical user data and historical classifications, to recognize an impact of the user activity or the user inactivity on a perceived trustworthiness of a user, as described with respect to FIG. 2. The training may involve assessing a likelihood that the user activity or the user inactivity indicates that a user is more or less trustworthy based on the historical user data and the historical classifications. The training may further involve assigning a value of high value, intermediate value, or low value, based on the likelihood. The training may further involve evaluating the assignment based on an evaluation criteria. The training may further involve revising the assignment into a classification as high value, intermediate value, or low value based on the evaluation.

Method 800 may include a step 805 of assigning a weight to the partitioned user data based on the category of user activity and the classification. The weight may indicate a significance of the user activity or the user inactivity, as described with respect to FIG. 4. In some embodiments, the weight may be a numerical multiplier, as described with respect to FIG. 4. In some embodiments, the category of user activity of financial activity may be assigned a greater weight than the weight assigned to the category of user activity of non-financial activity. In some embodiments, the weight may be proportional to a likelihood that the user activity indicates trust or risk such that the category of user activity that better reflects trustworthiness or risk aversion of the user may be assigned a weight greater than another category of activity that does not reflect the trustworthiness of the user as well.

Method 800 may include a step 806 of continuously calculating, using a statistical trust model, a risk assessment score. The statistical trust model may be configured to predict trustworthiness of the user by summing a base risk assessment score and an impact associated with the user activity or the user inactivity, where the impact is a product of a nonlinear, time-weighted penalty curve function and the weight, as described with respect to FIG. 2. In some embodiments, the risk assessment score may be a numerical score. In some embodiments, the risk assessment score may be used to advise the institution and its representatives on how trustworthy the user may be and how likely the user may be to repay borrowed money on time to help the institution decide whether to approve the user's application for a financial instrument and what terms to offer the user.

Method 800 may include a step 807 of detecting whether a change in the risk assessment score is greater than a threshold amount. A threshold amount, as described herein, may refer to a defined limit or quantity on either side of the risk assessment score which, if reached or exceeded, may trigger an event. Here, the threshold amount may be a number of points where the risk assessment score is a numerical score. In some embodiments the threshold amount may be a predetermined value, such as, for example, 15 points. For example, the risk assessment score may be a numerical score ranging from 0 to 300. The risk assessment score may be calculated to be 256. Where the threshold amount is 15 points, changes, by either a score increase or a score decrease, to the risk assessment score of more than 15 points may exceed the threshold amount.

Method 800 may include a step 808 of delivering a message to a user device upon detecting the change in the risk assessment score is greater than the threshold amount. In some embodiments, the message may include a congratulatory note when the change in the risk assessment score is a score increase that is greater than the threshold amount. For example, where the threshold amount is 15 points, a change in the risk assessment score that is a score increase of more than 15 points may trigger the message including the congratulatory note. In some embodiments, the message may include a warning to the user when the change in the risk assessment score is a score decrease that is greater than the threshold amount. For example, where the threshold amount is 15 points, a change in the risk assessment score that is a score decrease of more than 15 points may trigger the message including the warning.

In some embodiments, the message may include a report of user activity from a period of time and how the user activity impacted the risk assessment score. Report, as described herein, may refer to a recapitulation of user activity and user inactivity for a period of time, such as one week or one month. In some embodiments, the report may include a line item list of user activity and user inactivity along with the user activity or user inactivity's numerical impact on the risk assessment score. In such an embodiment, the message may advise the user to engage in or cease user activity to improve the user's risk assessment score. In some embodiments, the message may be delivered via text message, push notification, email, phone call, fax, direct message, or to a user account.

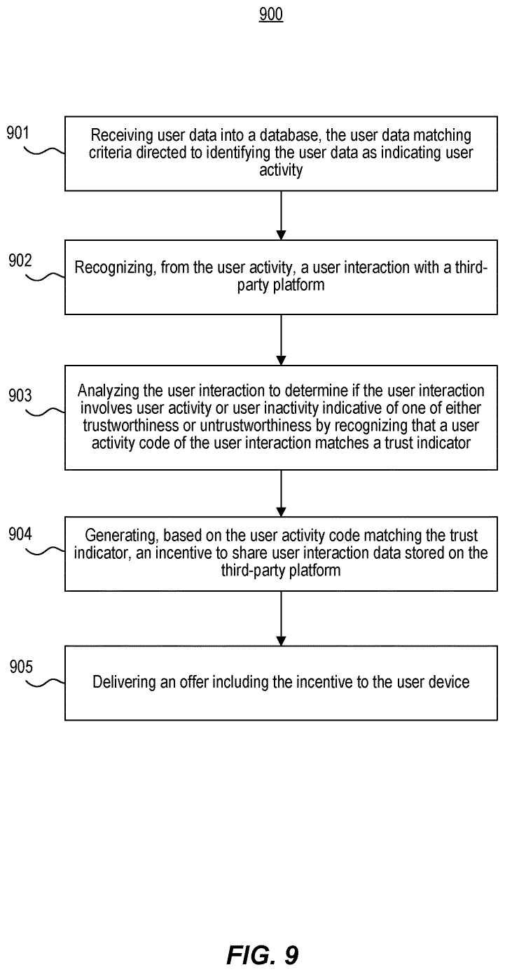

FIG. 9 depicts a flow chart for a method of incentivizing granting access to user data. Some embodiments pertain to incentivizing users to share external customer data. Such embodiments may involve a computer system, for example, at a bank or institution, that incentivizes users to share external customer data.

Method 900 may include a step 901 of receiving user data into a database. The user data may match criteria directed to identifying the user data as indicating user activity, as described with respect to FIG. 4.

Method 900 may include a step 902 of recognizing, from the user activity, a user interaction with a third-party platform. User interaction, as described herein, may refer to communication between the user and an interface, product, business, application, person, or other entity. Third-party platform, as further described herein, may refer to, for example, businesses, websites, or digital storefronts on a user device. In some embodiments, the third-party platform may be part of an application on the user device. In some embodiments, the third-party platform may include digitized activity from a physical location, such as a physical store. In some embodiments, recognizing user interaction with a third-party platform may involve gathering and analyzing user data or institution records. Recognizing may involve performing a keyword search or database query on the user data or institution records. In some embodiments, the user data or institution records may be filtered based on a time constraint or based on relevance.

Method 900 may include a step 903 of analyzing the user interaction to determine if the user interaction involves user activity or user inactivity indicative of one of either trustworthiness or untrustworthiness. In some embodiments, the determination may involve recognizing that a user activity code of the user interaction matches a trust indicator. Trust indicator, as described herein, may refer to an element or characteristic of user interaction that tends to highlight a user's trustworthiness. Trust indicator, as described herein, may include, for example, a payment of a bill having a due date, where the payment being made before or after the due date is indicative of trustworthiness. In some embodiments, the trust indicator may be a subscription for a product, the subscription being less expensive than single purchases of the product, where opting for the subscription is indicative of trustworthiness. In some embodiments, the trust indicator may be a donation fulfilling a promise to contribute funds, where the donation is indicative of trustworthiness. In some embodiments, the trust indicator may be an attendance record confirming an attendance after a registration, the attendance being indicative of trustworthiness. In some embodiments, the trust indicator may be a promise. In some embodiments, the user data may include user activity and user inactivity, which may include a user interaction. The user interaction may be identified by user activity codes that identify user interaction as, for example, a payment, subscription, donation, registration, or promise. In some embodiments, there may be user activity codes for favors, log ins, attendances, transfers, and other categories of user interaction. In some embodiments, the user interaction may be categorized as one of financial activity, non-financial activity, and financial-adjacent activity, as described with respect to FIG. 2. In some embodiments, the user activity codes may match the trust indicators such that, if the user interaction is identified by a user activity code that matches the trust indicator, then the user interaction may involve user activity or user inactivity indicative of trustworthiness or untrustworthiness. In some embodiments, there may be a list of user activity codes that the institution determines correspond to and therefore match the trust indicator.

Method 900 may include a step 904 of generating an incentive to share user interaction data stored on the third-party platform. The incentive may be generated based on the user activity code matching the trust indicator. Incentives, as described herein, may refer to something that encourages a user to engage in or avoid a particular action. Here, the incentive may refer to a reward that may be provided to the user conditioned on the user sharing the external user data. In some embodiments, the incentive may include a predetermined increase in a user's risk assessment score. In some embodiments, where the third-party platform is a paid service, the incentive may include a discount for the third-party platform. In some embodiments, the incentive may include a coupon for products sold on the third-party platform. External user data, as herein described, may be third-party data. Method 900 may include a step 905 of delivering an offer including the incentive to the user device. Offer, as described herein, may be a notice provided to the user that they may receive the incentive if they agree to share the external user data. In some embodiments, the offer may be delivered via text message, push notification, email, phone call, fax, direct message, or to a user account.

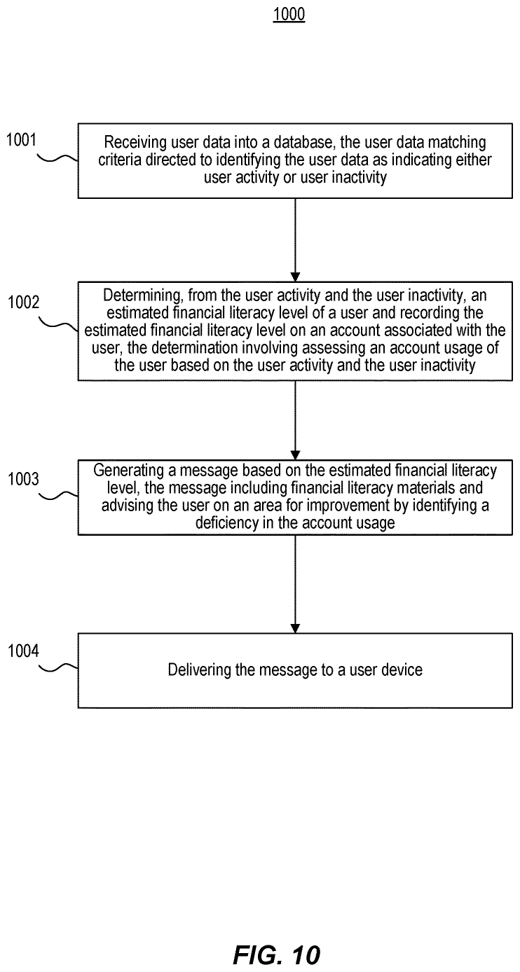

FIG. 10 depicts a flow chart for a method of assessing financial literacy of a user. Some embodiments pertain to assessing user financial knowledge, teaching financial literacy, and improving user creditworthiness or trustworthiness. Such embodiments may involve a computer system, for example, at a bank or institution, that assesses user financial knowledge, teaching financial literacy, and improving user creditworthiness or trustworthiness.

Method 1000 may include a step 1001 of receiving user data into a database. The user data may match criteria directed to identifying the user data as indicating either user activity or user inactivity, as described with respect to FIG. 4. In some embodiments, the received user data may include user data that does not meet the criteria, such as user age.

Method 1000 may include a step 1002 of determining, from the user activity and the user inactivity, an estimated financial literacy level of a user. In some embodiments, the estimated financial literacy level may be recorded on an account associated with the user. In some embodiments, the determination may involve assessing an account usage of the user based on the user activity and the user inactivity. Financial literacy level, as described herein, may be a qualitative or quantitative rating of the user's knowledge of banking and personal finance. In some embodiments, the estimated financial literacy level may be a numerical level. In some embodiments, the financial literacy level may be a qualitative descriptor. For example, the estimated financial literacy level may be one of either beginner, intermediate, proficient, advanced, or expert. In some embodiments, determining an estimated financial literacy level of the user may involve confirming a user's exposure to several financial tools, resources, and techniques. In one embodiment, confirming the user's exposure may involve the use of logical tests, such as determining whether a condition is true or false. Logical searches using conditions such as “where,” “or,” and “and” may also be used to perform database queries.

For example, determining an estimated financial literacy level of the user may involve assessing the account usage of the user, such as whether, and the extent to which, the user has, for example, used a credit card, used a debit card, set a savings goal, made an on-time credit card payment, set up automatic payments for the credit card, set up automatic payments for rent and utilities, logged into their user account on a computer, downloaded an institution's mobile application, logged into their user account on the institution's mobile application, contributed to investment accounts, checked a credit score, set up a meeting with an institution, contributed to a retirement account, kept an account balance above a minimum level, used an institution's budgeting tool, and ordered a check book. In one embodiment, exposure to each financial tool, resource, and technique may be worth one point with the total number of possible points being the number of financial tools, resources, and techniques checked for. In some embodiments, the logical tests and logical searching may involve a time component, recognizing that if a threshold amount of time, such as three years, has passed since the user's exposure, then the user may need or desire a refresher. In such a case, the user's exposure happening more than a threshold amount of time from the present may be worth half of a point. Checking for the user's exposure may be an efficient assessment of a user's ability to manage and take charge of their finances.

In some embodiments, the user data may be assessed more in depth to discover an extent that the user knows about or is exercising financial tools, resources, and techniques. For example, determining an estimated financial literacy level of the user may involve determining a monthly income and total monthly expenses from the user data to determine a user's savings rate. The user's savings rate may then indicate whether the user may benefit from learning about, for example, budgeting.

Method 1000 may include a step 1003 of generating a message based on the estimated financial literacy level. The message may include financial literacy materials and may advise the user on an area for improvement by identifying a deficiency in the account usage. Financial literacy materials, as described herein, may refer to resources that teach financial literacy to the user. In some embodiments, the financial literacy materials may include a course, such as a financial literacy course. In some embodiments, the message may include advice to complete a financial literacy course based on the user age being below, for example, 25 years. In some embodiments, the financial literacy materials may include a digital brochure or document. In some embodiments, an institution may condition access to a financial product on a user's completion of a financial literacy course based on a risk assessment score, user age, parental controls, or the age of the user's account. In some embodiments, completing the financial literacy course or reviewing the financial literacy materials may increase a user's risk assessment score, as described with respect to FIG. 2. Method 1000 may include a step 1004 of delivering the message to a user device. In some embodiments, the message may be delivered via text message, push notification, email, phone call, fax, or direct message. In some embodiments, the message may be delivered to an account.

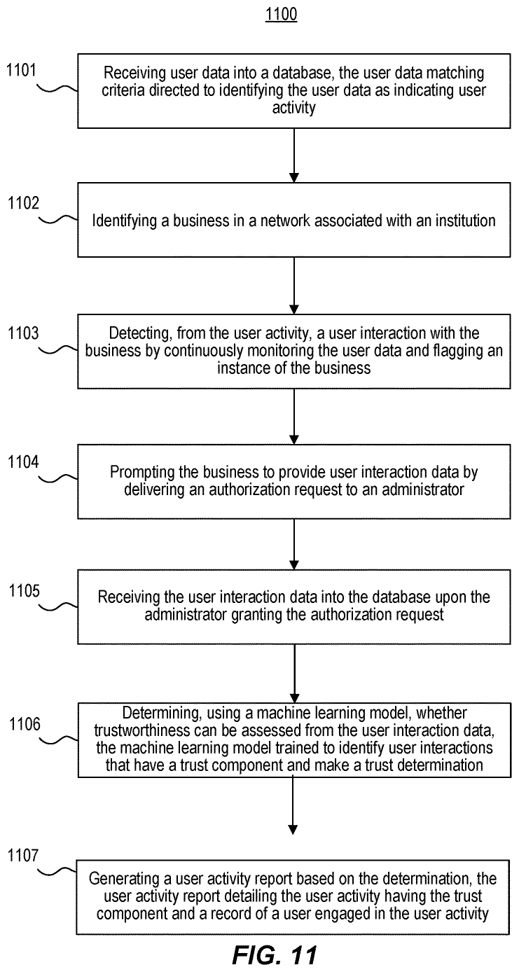

FIG. 11 depicts a flow chart for a method of assessing user behavior. Some embodiments pertain to gathering and evaluating user data from businesses in an institution's network. Such embodiments may involve a computer system, for example, at a bank or institution, that gathers and evaluates user data from businesses in an institution's network.

Method 1100 may include a step 1101 of receiving user data into a database. The user data may match criteria directed to identifying the user data as indicating either user activity or user inactivity, as described with respect to FIG. 4.

Method 1100 may include a step 1102 of identifying a business in a network associated with an institution. In some embodiments, the institution may have a network of businesses that it partners with to provide deals or recommendations to users. The network, as described herein, may refer to a set of individual or corporate contacts the institution has a relationship with or does business with. Identifying the business in the network may involve gathering and analyzing institution records. Identifying may involve performing a keyword search or database query on institution records. In some embodiments, institution records may be filtered based on a time constraint or based on relevance. For example, a business may have been in the network in the past but may no longer be in the network. Such a business may be filtered out of institution records based on the time constraint.

Method 1100 may include a step 1103 of detecting, from the user data, a user interaction with the business by continuously monitoring the user data and flagging an instance of the business. Monitoring the user data to detect user interaction with the business may involve gathering and analyzing user data. Monitoring and detecting may involve performing a keyword search or database query on the user data. In some embodiments, institution records may be filtered based on a time constraint or based on relevance.

Method 1100 may include a step 1104 of prompting the business to provide user interaction data, as described with respect to FIG. 2, by delivering an authorization request to an administrator. In some embodiments, the user interaction data may include, for example, a payment identifying a spending habit of a user that may be assessed for trustworthiness. In some embodiments, the user interaction data may include a registration and an attendance record that may be assessed for trustworthiness. In some embodiments, the user interaction data may include a subscription that may be assessed for trustworthiness. In some embodiments, the user interaction data may include a donation that may be assessed for trustworthiness. In some embodiments, the user interaction data may impact a user's risk assessment score, as described with respect to FIG. 2. Authorization request, as described herein, may be a formal mechanism to grant or obtain permission to access, inspect, or receive data or systems from the business in the institution's network. The authorization request may define a scope of information to be shared, parties involved, and a duration of access to the shared data or systems. In some embodiments, the authorization request may be sent from an institution platform to a third-party platform. For example, the authorization request may request that temporary access to user interaction data for User U be granted to the institution for a period of one month. In some embodiments, the institution may request user interaction data from several users with the same request. The business in the institution's network may receive the authorization request on the third-party platform and may grant or deny the request.

Method 1100 may include a step 1105 of receiving the user interaction data into the database upon the administrator granting the authorization request. In some embodiments, the business in the institution's network may share requested data or systems using an API, as described with respect to FIG. 6, or may grant limited and secure access to the third-party platform where the data and systems may be viewed and copied.

Method 1100 may include a step 1106 of determining, using a machine learning model, whether trustworthiness can be assessed from the user interaction data. The machine learning model may be trained to identify user interactions that have a trust component and make a trust determination.

The machine learning model, as described with respect to FIG. 2 and further described herein, may be used to determine whether trustworthiness can be assessed from the user interaction data. In some embodiments, the determination may be a binary response with the machine learning model outputting yes or no. The machine learning model may be trained from historical trust data, including historical user interaction data and historical determinations. The historical user interaction data may include user activity and user inactivity, as well as whether a user's trustworthiness may be implicated by the user activity or the user inactivity. The historical trust data may be data from a period of time, such as one month or one year, prior to present day. In some embodiments, the machine learning model may be trained to recognize that trustworthiness may be implicated by user interactions involving the user being reliable and consistent, accountable and honest, the user having integrity and being ethical, the user being proactive and responsible, and the user being transparent and cooperative. Thus, user interactions involving reliability and consistency, accountability and honesty, interpersonal integrity, ethical conduct, proactivity and responsibility, or transparency and cooperation may be considered to have a trust component. In some embodiments, the machine learning model may also be trained to determine whether the user interactions favor trusting the user or not trusting the user.

In one embodiment, the machine learning model may be trained from user interaction data, including user activity and user inactivity. The machine learning model may be input user interactions, such as the user logging into a third-party platform and making a purchase, reservation, registration, or donation. For example, the machine learning model may receive user interactions showing that the user received a payment request from another user on a peer-to-peer payment application, logged into the application and viewed the request, and did not fulfill the request until three weeks later; the user used a restaurant reservation service to make a dinner reservation and the user showed up to the reservation on time; and the user utilized a grocery store's mobile application to search for a product.

During training, the machine learning model may be trained that trustworthiness can likely be assessed from user interactions involving a lack of accountability and cooperation. For example, the machine learning model may learn that when a first user fails to pay back a second user for an extended period of time, the first user may be considered unaccountable and uncooperative. The machine learning model may learn that trustworthiness can be assessed from user interactions involving accountability and cooperation, and since the user lacked cooperation and accountability, the user interaction may favor not trusting the user.

Similarly, the machine learning model may be trained that trustworthiness can likely be assessed from user interactions involving reliability. For example, the machine learning model may learn that when a user arrives on time for a dinner reservation, the user may be considered reliable. The machine learning model may learn that trustworthiness can be assessed from user interactions involving reliability, and since the user displayed reliability, the user interaction may favor trusting the user.

Similarly, the machine learning model may be trained that trustworthiness generally cannot be assessed from user interactions involving neutral informational inquiries. For example, the machine learning model may learn that a user using a search function on a grocer's mobile application is likely a neutral information inquiry and therefore does not likely implicate trustworthiness. Thus, the machine learning model may learn that trustworthiness likely cannot be assessed from user interactions involving neutral informational inquiries.

The machine learning model may learn from the examples and go through further training of receiving user interaction data for a period of time and determining whether trustworthiness may be determined from the user interactions. For each user interaction, the machine learning model may determine whether the user interaction implicates trustworthiness and whether the user interaction favors trusting the user or not trusting the user. The determination may then then be confirmed or corrected until the machine learning model is able to make accurate determinations a threshold amount of the time.

For example, the machine learning model may receive user interaction data, which may include that the user pledged to make a donation to an organization and followed through with sending the money and the user did not claim anything at customs when entering Country C but, upon the user's bag being searched, the user was found in violation of customs rules. The machine learning model may determine that the user pledging to make a donation and following through with the donation involves honesty and reliability, which may be assessed for trustworthiness. The machine learning model may determine that trustworthiness may be assessed and the user interaction favors trusting the user. The machine learning model may be informed that its classification is correct and continue training with additional examples.

In another example, the machine learning model may determine that the user failing to claim anything at customs and getting caught traveling with prohibited items involves dishonesty and lack of accountability, which may be assessed for trustworthiness. The machine learning model may determine that trustworthiness may be assessed, and the user interaction favors not trusting the user. The machine learning model may be informed that its classification is correct and continue training with additional examples.

The machine learning model may be configured to accept specific inputs. For example, the machine learning model may receive user interaction data. The machine learning model may receive the user interaction data, determine whether trustworthiness may be assessed from the user interaction, and determine whether the user interaction favors trusting the user or not trusting the user. In some embodiments, the determinations may be used to train and retrain the machine learning model to determine which user interactions, including user activity and user inactivity, may implicate trustworthiness and whether user interactions favor trusting the user.

Method 1100 may include a step 1107 of generating a user activity report based on the determination. The user activity report may detail the user activity having the trust component and a record of a user engaged in the user activity. User activity report, as described herein, may refer to a formal or informal structured document, presenting factual information, analysis, or recommendations to aid in future decision making. In some embodiments, the report may have a predefined format. In some embodiments, the predefined format may be selected by an institution. The predefined format may be, for example, a spreadsheet or a memorandum. The user activity report may include the information in a table or list form or may include graphics, such as line graphs, bar graphs, and pie charts. In some embodiments, the user activity report may include information about user interaction data for the business, a record of which user interactions have a trust component, and information tying the user interaction with a user. The user activity report may include information about which users interact with the business in the network associated with the institution, how the users interact, and when the users interact. In some embodiments, the user activity report may advise the institution to consider the user activity having the trust indicator when evaluating a loan candidate. In some embodiments, a portion of the user activity report corresponding to a user may be delivered to a user device.

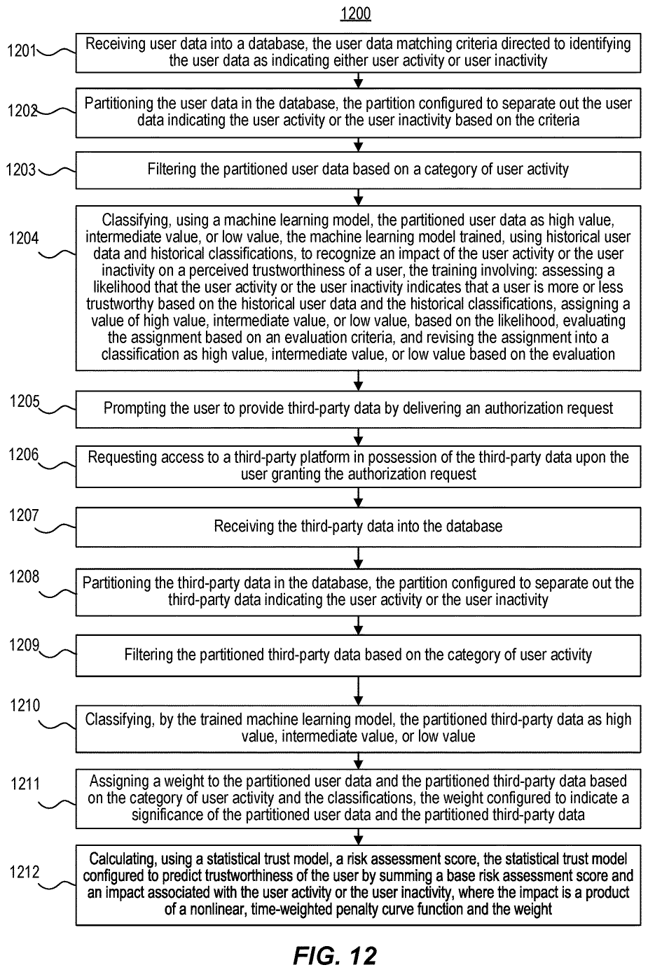

FIG. 12 depicts a flow chart for a method of determining a risk assessment score. Some embodiments pertain to assessing third-party application data to determine user trustworthiness. Such embodiments may involve a computer system, for example, at a bank or institution, that assesses third-party application data to determine user trustworthiness.

Method 1200 may include a step 1201 of receiving user data into a database. The user data may match criteria directed to identifying the user data as indicating either user activity or user inactivity, as described with respect to FIG. 4. Method 1200 may include a step 1202 of partitioning the user data in the database. The partition may be configured to separate out the user data indicating the user activity or the user inactivity, based on the criteria, as described with respect to FIG. 4.

Method 1200 may include a step 1203 of filtering the partitioned user data based on a category of user activity, as described with respect to FIG. 4. In some embodiments, the category of user activity may be one of financial activity, financial-adjacent activity, or non-financial activity, as described with respect to FIG. 2. Method 1200 may include a step 1204 of classifying, using a machine learning model, the partitioned user data as high value, intermediate value, or low value. The machine learning model may be trained to recognize an impact of the user activity or the user inactivity on a perceived trustworthiness of a user, as described with respect to FIG. 2. The training may involve assessing a likelihood that the user activity or the user inactivity indicates that a user is more or less trustworthy based on the historical user data and the historical classifications. The training may further involve assigning a value of high value, intermediate value, or low value, based on the likelihood. The training may further involve evaluating the assignment based on an evaluation criteria. The training may further involve revising the assignment into a classification as high value, intermediate value, or low value based on the evaluation.

Method 1200 may include a step 1205 of prompting the user to provide third-party data by delivering an authorization request. Third-party data, as described with respect to FIG. 2 and further described herein, may refer to information related to the user's connection and interaction with a third-party platform. The authorization request may define a scope of information to be shared, and a duration of access to the data or systems. In some embodiments, the authorization request may be sent from an institution platform to a user via email or push notification, or the request may be delivered to the user account. For example, the authorization request may request that User U grant permission for the institution to obtain third-party data from the third-party platform for a period of one month. In some embodiments, the third-party platform may be part of an application on a user device. The user may grant or deny the authorization request. In some embodiments, the authorization request may include an incentive to provide the third-party data. For example, the institution may incentivize the user by, for example, offering a reward of credit card points or offering a coupon for goods or services from the third party. In some embodiments, the incentive may include a predetermined increase in a user's risk assessment score.

Method 1200 may include a step 1206 of requesting access to a third-party platform in possession of the third-party data, as described with respect to FIG. 2, upon the user granting the authorization request. Gaining access to the third-party platform and the third-party data may ensure a fuller picture of the user activity and user inactivity that may be used to determine trustworthiness and/or a risk assessment score. In some embodiments, after the user grants the request, an agreement, which may include the terms of the authorization request, that the authorization request was granted, the user's signature, and an institution representative's signature, may be sent to the third party to initiate data sharing. The third party may honor the agreement and share the data or may refuse to provide access to the third-party platform. In some embodiments, approval by third party may be bypassed or unnecessary. Method 1200 may include a step 1207 of receiving the third-party data into the database, as described with respect to FIG. 4. In some embodiments, the third party may share the third-party data or systems using an API, as described with respect to FIG. 6, or may grant limited and secure access to the third-party platform where the data and systems may be viewed and copied.

Method 1200 may include a step 1208 of partitioning the third-party data in the database. The partition may be configured to separate out the third-party data indicating the user activity or the user inactivity, as described with respect to FIG. 4. Method 1200 may include a step 1209 of filtering the partitioned third-party data based on the category of user activity, as described with respect to FIG. 4. In some embodiments, the category of user activity may be one of financial activity, financial-adjacent activity, or non-financial activity, as described with respect to FIG. 2. Method 1200 may include a step 1210 of classifying, by the trained machine learning model, the partitioned third-party data as high value, intermediate value, or low value. The machine learning model may be trained, using historical third-party data and historical classifications.

Method 1200 may include a step 1211 of assigning a weight to the partitioned user data and the partitioned third-party data based on the category of user activity and the classification. The weight may be configured to indicate a significance of the partitioned user data and the partitioned third-party data, as described with respect to FIG. 4. In some embodiments, the weight may be a numerical multiplier, as described with respect to FIG. 4. In some embodiments, the category of user activity of financial activity may be assigned a greater weight than the weight assigned to the category of user activity of non-financial activity. In some embodiments, the weight may be proportional to a likelihood that the user activity indicates trust or risk such that the category of user activity that better reflects trustworthiness or risk aversion of the user may be assigned a weight greater than another category of activity that does not reflect the trustworthiness of the user as well.

Method 1200 may include a step 1212 of calculating, using a statistical trust model, a risk assessment score. The statistical trust model may be configured to predict trustworthiness of the user by summing a base risk assessment score and an impact associated with the user activity or the user inactivity, where the impact is a product of a nonlinear, time-weighted penalty curve function and the weight, as described with respect to FIG. 2. In some embodiments, the risk assessment score may be a numerical score. In some embodiments, the risk assessment score may be displayed on an account. In some embodiments, the risk assessment score may be used to advise the institution and its representatives on how trustworthy the user may be and how likely the user may be to repay borrowed money on time to help the institution decide whether to approve the user's application for a financial instrument and what terms to offer the user.

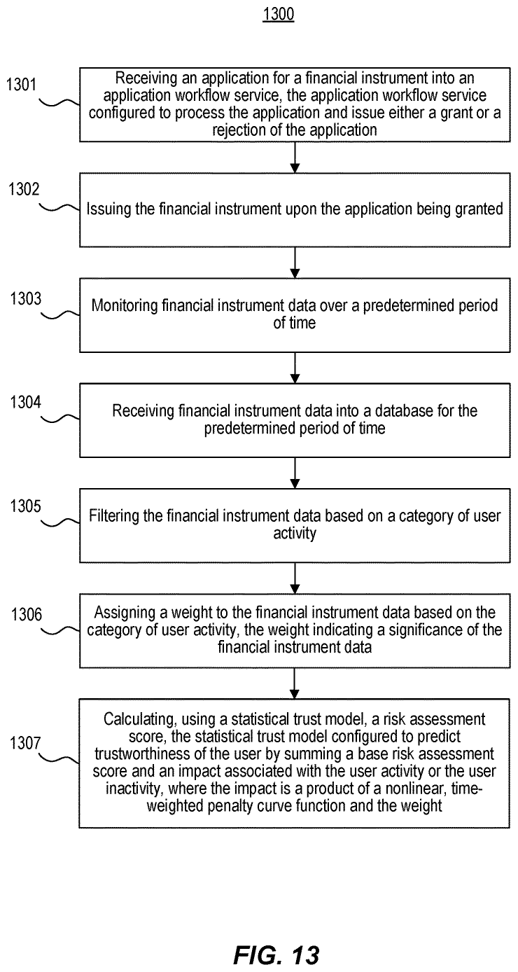

FIG. 13 depicts a flow chart for a method of assessing trustworthiness of a user. Some embodiments pertain to using temporary financial instruments to assess user trustworthiness. Such embodiments may involve a computer system, for example, at a bank or institution, that uses temporary financial instruments to assess user trustworthiness.

Method 1300 may include a step 1301 of receiving an application for a financial instrument into an application workflow service. The application workflow service may be configured to process the application and issue either a grant or a rejection of the application. The application workflow service, as described herein, may refer to an automated service for managing the evaluation and approval of an application for a financial instrument. For example, the application workflow service may be notified that a user submitted a credit card application and receive a user's submitted application materials. The application workflow service may scan the application materials and extract key information required for a decision on the application, such as a user's personally identifying information. The application workflow service may then process a credit check to determine if the user is a good candidate for the credit card. The application workflow service may then decide to grant or deny the user's credit card application. In some embodiments, the financial instrument may be a risk assessment card. A risk assessment card, as described herein, may refer to a credit card-like financial instrument used to evaluate a user's trustworthiness by providing the user with financial services and providing the institution with user data, including how and when the user uses the risk assessment card. In some embodiments, the risk assessment card may be only a temporary financial instrument, lasting for only three months, for example.

Method 1300 may include a step 1302 of issuing the financial instrument upon the application being granted. Issuing the financial instrument may involve sending the user information about the financial instrument and adding an account for the financial instrument within the user account so the user may manage and monitor the financial instrument. Method 1300 may include a step 1303 of monitoring financial instrument data over a predetermined period of time. Financial instrument data, as described with respect to FIG. 2 and further described herein, may refer to information and attributes connected to a financial instrument including the parties involved, payment history, purchase history, and card services information, including loss history and theft history.

Method 1300 may include a step 1304 of receiving financial instrument data into a database for the predetermined period of time, as described with respect to FIG. 4. Method 1300 may include a step 1305 of filtering the financial instrument data based on a category of user activity, as described with respect to FIG. 4. In some embodiments, the category of user activity may be one of financial activity, financial-adjacent activity, or non-financial activity, as described with respect to FIG. 2. Method 1300 may include a step 1306 of assigning a weight to the financial instrument data based on the category of user activity. The weight may indicate a significance of the financial instrument data, as described with respect to FIG. 4. In some embodiments, the weight may be a numerical multiplier, as described with respect to FIG. 4. In some embodiments, the category of financial activity may be assigned a greater weight than the weight assigned to the category of non-financial activity. In some embodiments, the weight may be proportional to a likelihood that the user activity indicates trust or risk such that the category of user activity that better reflects trustworthiness or risk aversion of the user may be assigned a weight greater than another category of activity that does not reflect the trustworthiness of the user as well.

Method 1300 may include a step 1307 of calculating, using a statistical trust model, a risk assessment score. The statistical trust model may be configured to predict trustworthiness of a user by summing a base risk assessment score and an impact associated with the user activity or the user inactivity, where the impact is a product of a nonlinear, time-weighted penalty curve function and the weight, as described with respect to FIG. 2. In some embodiments, the risk assessment score may be a numerical score. In some embodiments, the risk assessment score may be used to advise the institution and its representatives on how trustworthy the user may be and how likely the user may be to repay borrowed money on time to help the institution decide whether to approve the user's application for a financial instrument and what terms to offer the user.

Unless otherwise defined, all technical and scientific terms used herein have the same meaning as commonly understood by one of ordinary skill in the art. The materials, methods, and examples provided herein are illustrative only and not intended to be limiting.

According to actual instrumentation and equipment of preferred embodiments of the method and system of the present disclosure, several selected steps may be implemented by hardware or by software on any operating system of any firmware, or by a combination thereof. For example, as hardware, selected steps of the disclosure may be implemented as a chip or a circuit. As software or algorithm, selected steps of the disclosure may be implemented as a plurality of software instructions being executed by a computer using any suitable operating system. Selected steps of the method and system of the disclosure may be performed by a data processor, such as a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device,” it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally include a network or a computer network.

To provide for interaction with a user, the systems and techniques described herein can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back-end component (e.g., as a data server), or that includes a middleware component (e.g., an application server), or that includes a front end component (e.g., a client computer having a graphical user interface or a web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

The block diagrams in the figures illustrate the architecture, organizational entity, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the organizational entity involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

1. A system comprising:
a memory storing instructions; and
at least one processor configured to execute the stored instructions to:
receive user data into a database, the user data matching criteria directed to identifying the user data as indicating either user activity or user inactivity;
partition the user data in the database, the partition configured to separate out the user data indicating the user activity or the user inactivity based on the criteria;
filter the partitioned user data based on a category of user activity;
classify, using a machine learning model, the partitioned user data as high value, intermediate value, or low value, the machine learning model trained, using historical user data and historical classifications, to recognize an impact of the user activity or the user inactivity on a perceived trustworthiness of a user, the training involving:
assessing a likelihood that the user activity or the user inactivity indicates that a user is more or less trustworthy based on the historical user data and the historical classifications,
assigning a value of high value, intermediate value, or low value, based on the likelihood,
evaluating the assignment based on an evaluation criteria, and
revising the assignment into a classification as high value, intermediate value, or low value based on the evaluation;
assign a weight to the partitioned user data based on the category of user activity and the classification, the weight indicating a significance of the user activity or the user inactivity; and
calculate, using a statistical trust model, a risk assessment score, the statistical trust model configured to predict trustworthiness of the user by summing a base risk assessment score and an impact associated with the user activity or the user inactivity, where the impact is a product of a nonlinear, time-weighted penalty curve function and the weight.

2. The system of claim 1, wherein the category of user activity is one of financial activity, non-financial activity, or financial-adjacent activity.

3. The system of claim 2, wherein the financial activity has a greater weight than the non-financial activity.

4. The system of claim 2, wherein the financial-adjacent activity has a greater weight than the non-financial activity but a lesser weight than the financial activity.

5. The system of claim 1, wherein the weight is a numerical multiplier.

6. The system of claim 1, wherein the weight is proportional to a likelihood that the user activity indicates trust.

7. The system of claim 1, wherein the risk assessment score is displayed on an account.

8. The system of claim 1, wherein the risk assessment score is a numerical score.

9. The system of claim 8, wherein the numerical score is assigned a descriptive classifier.

10. A computer implemented method comprising the following operations performed by at least one processor:
receiving user data into a database, the user data matching criteria directed to identifying the user data as indicating either user activity or user inactivity;
partitioning the user data in the database, the partition configured to separate out the user data indicating the user activity or the user inactivity, based on the criteria;
filtering the partitioned user data based on a category of user activity;
classifying, using a machine learning model, the partitioned user data as high value, intermediate value, or low value, the machine learning model trained, using historical user data and historical classifications, to recognize an impact of the user activity or the user inactivity on a perceived trustworthiness of a user, the training involving:
assessing a likelihood that the user activity or the user inactivity indicates that a user is more or less trustworthy based on the historical user data and the historical classifications,
assigning a value of high value, intermediate value, or low value, based on the likelihood,
evaluating the assignment based on an evaluation criteria, and
revising the assignment into a classification as high value, intermediate value, or low value based on the evaluation;
assigning a weight to the partitioned user data based on the category of user activity and the classification, the weight indicating a significance of the user activity or the user inactivity; and
calculating, using a statistical trust model, a risk assessment score, the statistical trust model configured to predict trustworthiness of the user by summing a base risk assessment score and an impact associated with the user activity or the user inactivity, where the impact is a product of a nonlinear, time-weighted penalty curve function and the weight.

11. The method of claim 10, wherein the category of user activity is one of financial activity, non-financial activity, or financial-adjacent activity.

12. The method of claim 10, wherein the financial activity has a greater weight than the non-financial activity.

13. The method of claim 10, wherein the weight is a numerical multiplier.

14. The method of claim 10, wherein the weight is proportional to a likelihood that the user activity indicates trust.

15. The method of claim 10, wherein the risk assessment score is displayed on an account.

16. The method of claim 10, wherein the risk assessment score is a numerical score.

17. The method of claim 16, wherein the numerical score is assigned a descriptive classifier.

18. A non-transitory computer storage medium encoded with computer program instructions that when executed by one or more processors, cause the one or more processors to perform operations comprising:
receiving user data into a database, the user data matching criteria directed to identifying the user data as indicating either user activity or user inactivity;
partitioning the user data in the database, the partition configured to separate out the user data indicating the user activity or the user inactivity, based on the criteria;
filtering the partitioned user data based on a category of user activity;
classifying, using a machine learning model, the partitioned user data as high value, intermediate value, or low value, the machine learning model trained, using historical user data and historical classifications, to recognize an impact of the user activity or the user inactivity on a perceived trustworthiness of a user, the training involving:
assessing a likelihood that the user activity or the user inactivity indicates that a user is more or less trustworthy based on the historical user data and the historical classifications,
assigning a value of high value, intermediate value, or low value, based on the likelihood,
evaluating the assignment based on an evaluation criteria, and
revising the assignment into a classification as high value, intermediate value, or low value based on the evaluation;
assigning a weight to the partitioned user data based on the category of user activity and the classification, the weight indicating a significance of the user activity or the user inactivity; and
calculating, using a statistical trust model, a risk assessment score, the statistical trust model configured to predict trustworthiness of the user by summing a base risk assessment score and an impact associated with the user activity or the user inactivity, where the impact is a product of a nonlinear, time-weighted penalty curve function and the weight.

19-90. (canceled)
